(19) United States
(12) Patent Application Publication
(10) Pub. No.: US 2026/0169874 A1
(43) Pub. Date: Jun. 18, 2026

(54) DISASTER RECOVERY FOR DATA SHARING

(71) Applicant: Snowflake Inc., Bozeman, MT (US)

(72) Inventors: Harminter Singh Atwal, Bothell, WA (US); Hitesh Madan, Seattle, WA (US); Nithin Mahesh, Kirkland, WA (US); Vishnu Dutt Paladugu, Seattle, WA (US); Siddarth Ramadoss, Kirkland, WA (US); Sahaj Saini, Seattle, WA (US); Subramanian Sankara Subramanian, Mercer Island, WA (US); Siddharth Suresh, Toronto (CA); Chieh-Sheng Wang, San Mateo, CA (US); Di Wu, Newark, CA (US)

(21) Appl. No.: 18/983,554

(22) Filed: Dec. 17, 2024

(51) Int. Cl. G06F 11/20; G06F 11/16

(52) U.S. Cl. CPC G06F 11/2069; G06F 11/1662; G06F 11/2076

(57) ABSTRACT

Provided herein are systems and methods for configuring disaster recovery for data sharing. A method includes configuring a first failover group (FG) with a first set of data objects as a primary FG at a first deployment of a network-based database system, and configuring a first replication group (RG) with a second set of data objects as a current primary RG within the first FG. The first FG is replicated from the first deployment to a second FG in a second deployment of the network-based database system. The second FG includes a second RG as a replica of the first RG. The second FG is configured as the primary FG and the second RG as the current primary RG in the second deployment based on detecting a failover event in the first deployment. The method includes performing data replication based on the second RG being the current primary RG.

### TECHNICAL FIELD

Embodiments of the disclosure generally relate to databases and, more specifically, to disaster recovery configurations in connection with data-sharing functionalities performed in a database system.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Different database storage systems may be used to store different types of content, such as bibliographic, full text, numeric, and image content, that may need to be accessed or analyzed. Further, in computing, different database systems may be classified according to the organizational approach of the database. There are many different types of databases, including relational databases, distributed databases, cloud databases, object-oriented databases, and others. A key aspect in configuring database access is planning for access continuity during network disaster events.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system with a disaster recovery manager (DRM), in accordance with some embodiments of the present disclosure.

FIG. 2 is a block diagram illustrating the components of a compute service manager, in accordance with some embodiments of the present disclosure.

FIG. 3 is a block diagram illustrating components of an execution platform, in accordance with some embodiments of the present disclosure.

FIG. 4 illustrates an example regional-deployment map for the example database system of FIG. 1, in accordance with some embodiments of the present disclosure.

FIG. 5 illustrates an example global object in a primary deployment, which is accessible at other deployments, in accordance with some embodiments of the present disclosure.

FIG. 6 is a diagram of sharing data between two accounts in the same deployment using a direct share, in accordance with some embodiments of the present disclosure.

FIG. 7 illustrates example replication groups specifying different account objects, in accordance with some embodiments of the present disclosure.

FIG. 8 and FIG. 9 illustrate example replication group usage scenarios in connection with disaster recovery (DR) and data sharing, in accordance with some embodiments of the present disclosure.

FIGS. 10-17 illustrate example replication group configurations and usages, in accordance with some embodiments of the present disclosure.

FIG. 18 is a diagram of a listing auto fulfillment (LAF) using a replication group replica, in accordance with some embodiments of the present disclosure.

FIG. 19 is a diagram of a failover group including overlapping replication groups, in accordance with some embodiments of the present disclosure.

FIG. 20 is a diagram of generating a failover group replica during a failover event where the failover group replica includes overlapping replication groups, in accordance with some embodiments of the present disclosure.

FIG. 21 is a diagram of using a failover group replica during a failover event where the failover group replica includes a single overlapping replication group, in accordance with some embodiments of the present disclosure.

FIG. 22 is a diagram of using a failover group replica during a failover event where the failover group replica includes multiple overlapping replication groups, in accordance with some embodiments of the present disclosure.

FIG. 23 is a diagram of generating failover group replicas and a replication group replica before a failover event using a primary failover group with a single overlapping replication group, in accordance with some embodiments of the present disclosure.

FIG. 24 is a diagram of the primary failover group of FIG. 23 after a failover event, in accordance with some embodiments of the present disclosure.

FIG. 25 is a diagram of configuring a new primary failover group after a failover event using a primary failover group with a single overlapping replication group, in accordance with some embodiments of the present disclosure.

FIG. 26 is a flow diagram illustrating operations of a database system in performing a method for disaster recovery for data sharing, in accordance with some embodiments of the present disclosure.

FIG. 27 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a customer account. The data platform may include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth.

In an implementation of a data platform, a given database (e.g., a database maintained for a customer account) may reside as an object within, e.g., a customer account, which may also include one or more other objects (e.g., users, roles, privileges, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

As used herein, the term “object” (also referred to as “data object” or “global object”) is a data construct that is visible (e.g., accessible) in all (specified) deployments of a network-based database system. In some aspects, such an object can be modified in the source (primary) deployment and is read-only in target (or secondary) deployments.

As used herein, the term “replication group” (or RG) refers to a collection of objects (e.g., databases and share objects) that are selected for replication as a group. In some aspects, replication of RGs between deployments is performed transactionally and can be used for sharing data between accounts at one deployment or between accounts at different deployments.

In some aspects, an RG can be configured as an object storing a manifest of which objects to replicate from a source account (e.g., an account of a data provider), which target accounts (e.g., accounts of the data provider or a customer of the data provider such as a data consumer) to replicate these objects to, and at what schedule such replication can be performed. In this regard, using an RG in connection with data replication allows for the ability to replicate multiple databases with point-in-time consistency transactionally, the ability to replicate more than database objects transactionally including multiple account objects, and the ability to replicate automatically on a schedule. Additional benefits of using an RG include simplicity in data management, the ability to have related objects across different databases (e.g., across different remote deployment accounts of a data provider), the ability to replicate account metadata along with data, transactional consistency during replication across multiple databases, and simplified management of replication refreshes.

As used herein, the term “failover group” (or FG) is a variant of a replication group, which allows for any replica of the FG to be selected as the primary FG (e.g., during disaster recovery). In some aspects, account replication groups (ARGs) and account failover groups (AFGs) can be used for replication and failover of account-level objects.

As used herein, the terms “overlapping” and “non-overlapping” in relation to FGs and RGs refer to the presence (or absence) of a data object that belongs to multiple groups. For example, an RG can include a database that is also associated with an FG. In this case, the RG and the FG are overlapping (or nested) (e.g., the following expressions can be used for this configuration: the RG is overlapping with the FG, the RG is nested within the FG, or the FG includes the RG). When an RG and an FG do not have any common data objects (e.g., no common databases), the RG and the FG are non-overlapping.

Existing data-sharing techniques can be used to share data and applications across accounts in a network-based database system. However, such existing techniques do not support business continuity and disaster recovery scenarios. For example, in case of a regional outage or other network disaster (collectively referred to as a “failover event”), the customers lose their sharing setup. Similarly, the consumers lose their setup if they face an outage as well.

The disclosed techniques include adding these sharing setups (e.g., one or more replication groups) to a failover group. This configuration allows for a failover group replica in another region to act as the primary failover group while still supporting continued data sharing from the replication group that is part of the new primary failover group. In this regard, data providers can continue to share data from the failover region in case of an outage, and consumers can continue to receive data updates in a new region (e.g., by using the replication group that is part of the failover group). Additionally, the disclosed techniques allow customers of a network-based database system to become providers and also set up DR guarantees for their data and application to be able to fulfill their consumers in case of any outages to the provider's primary region.

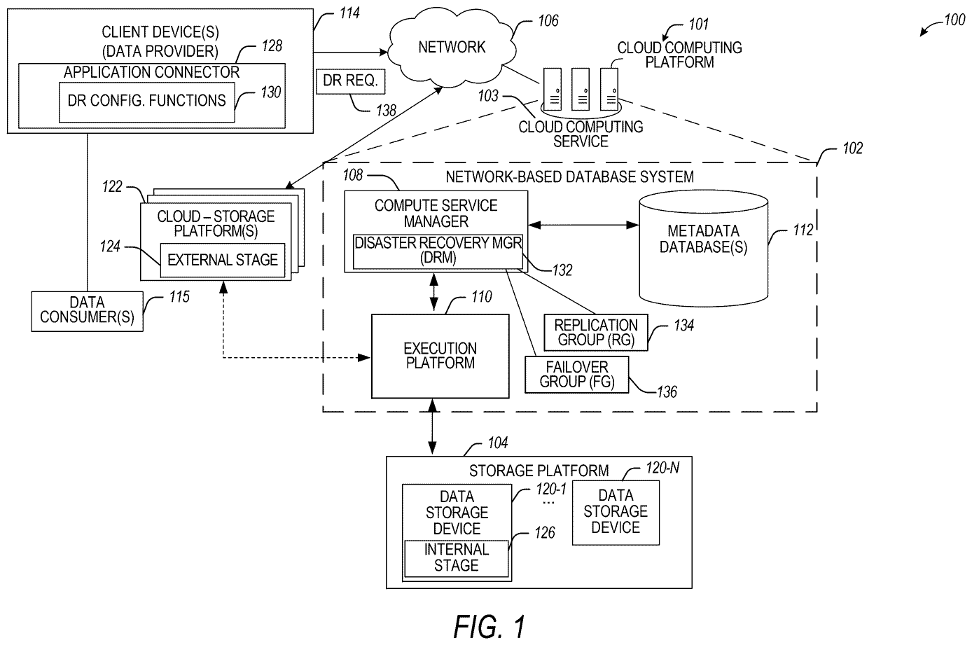

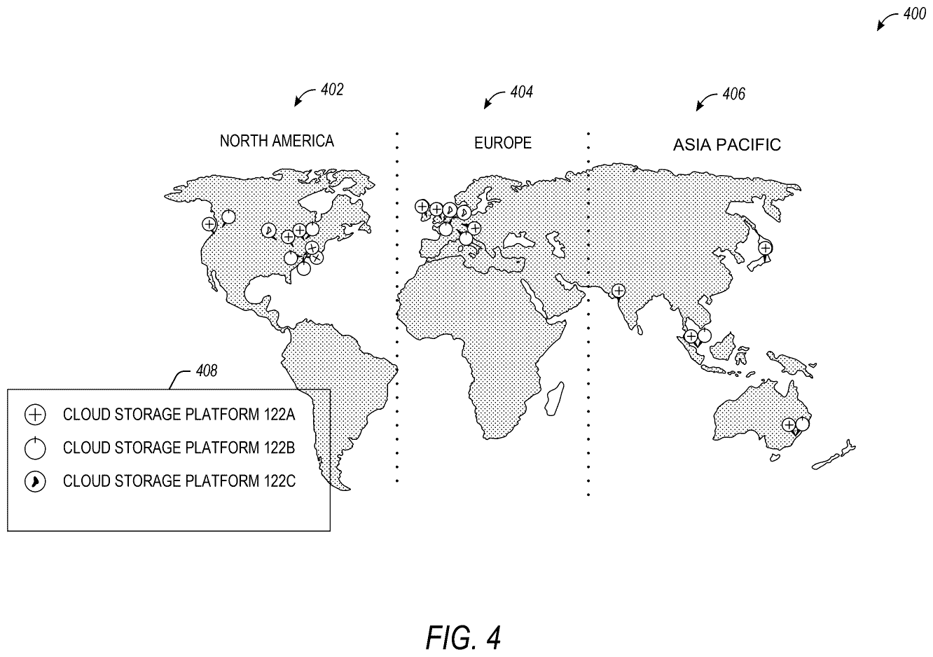

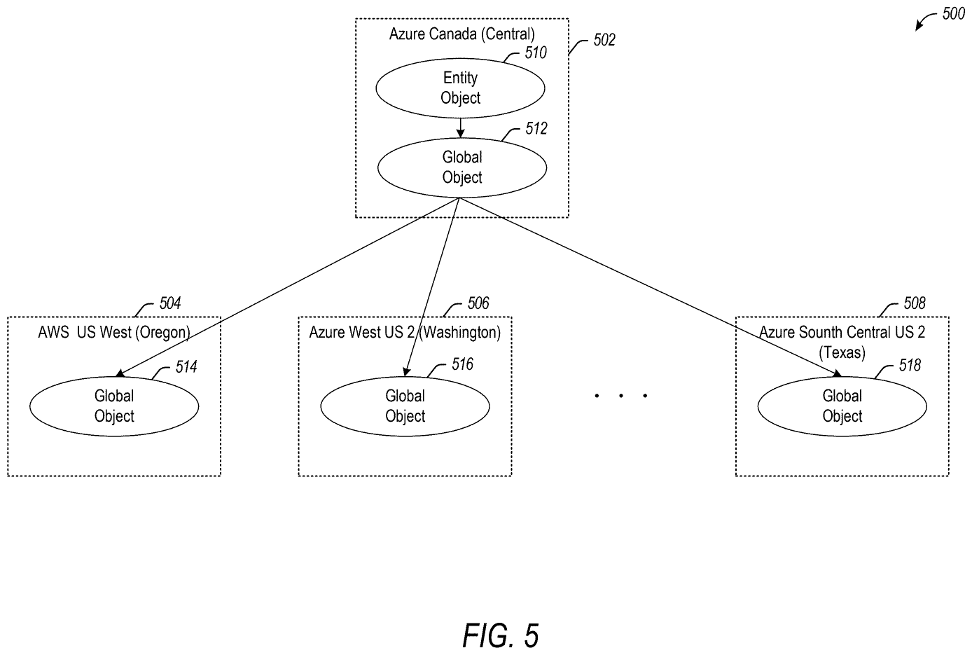

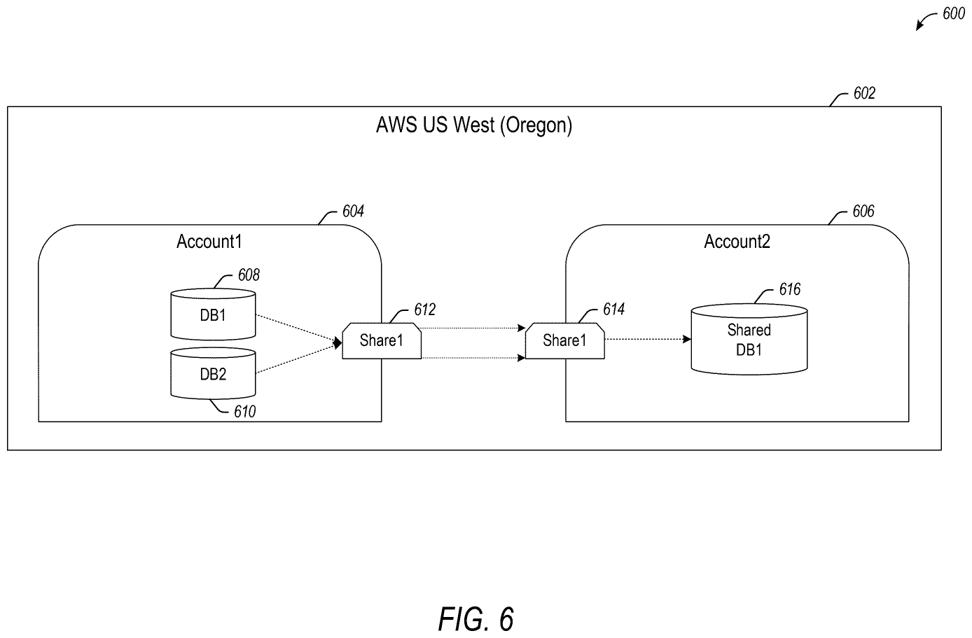

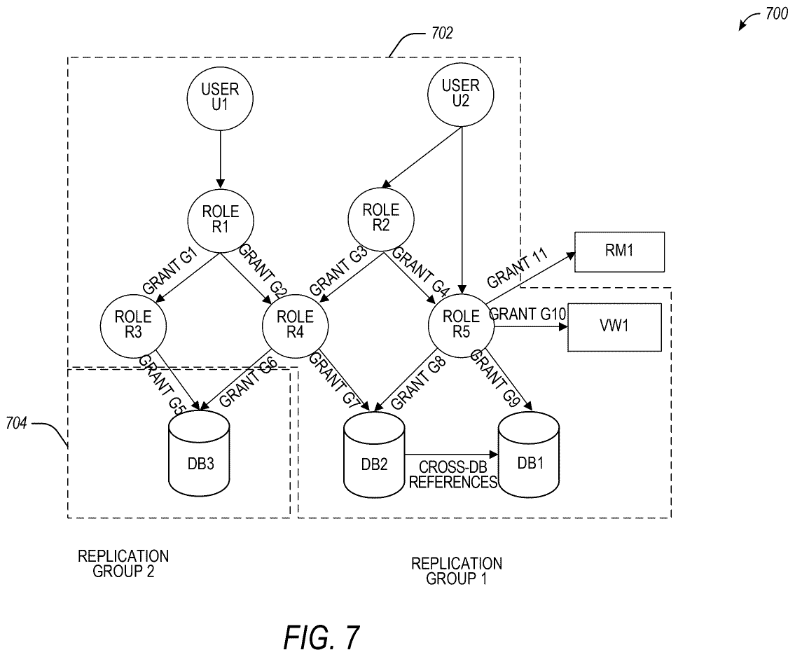

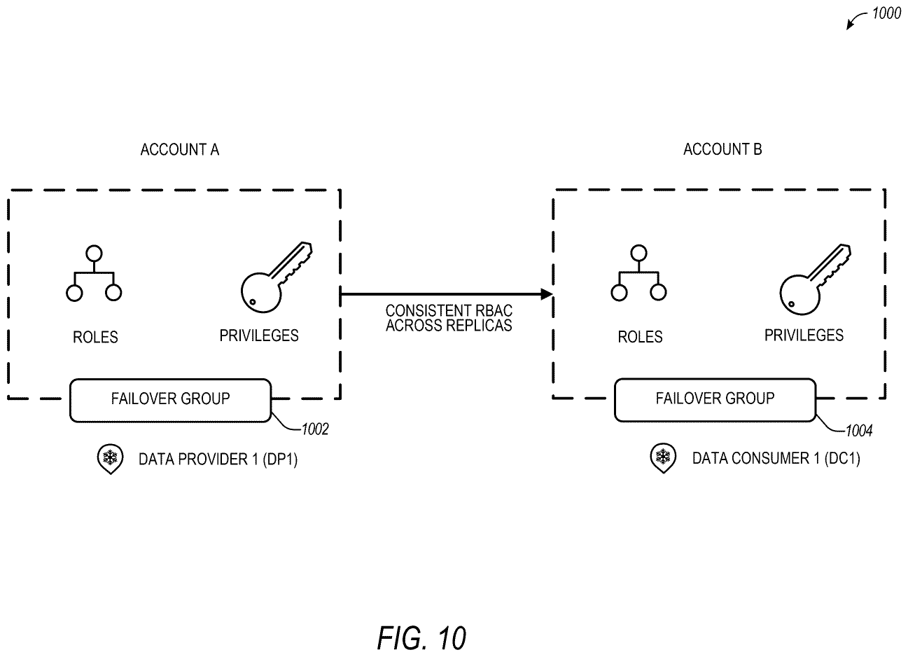

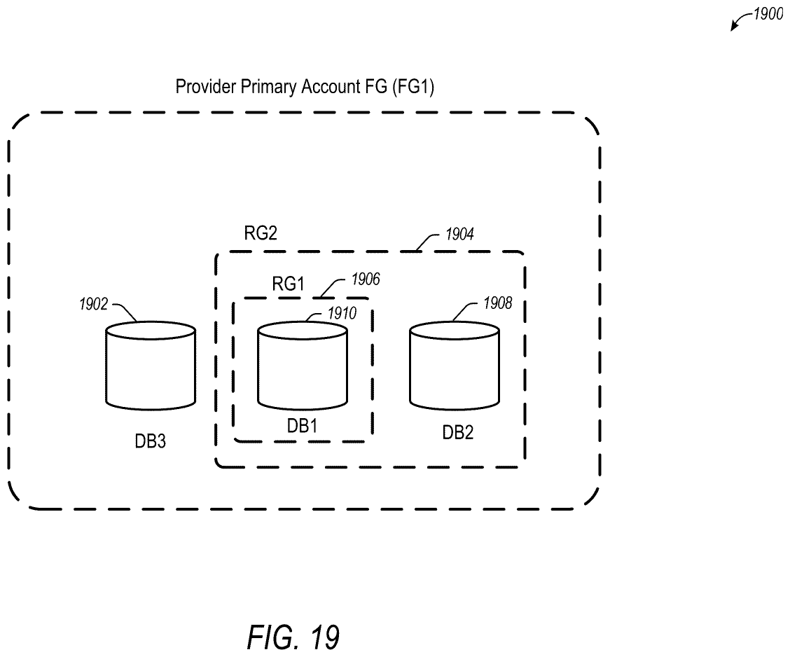

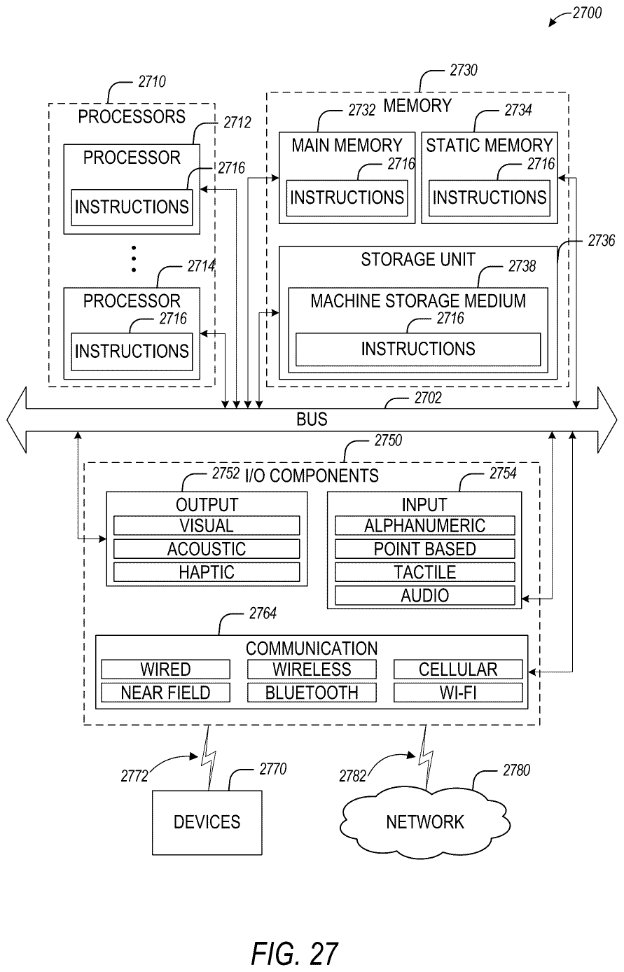

The various embodiments that are described herein are described with reference where appropriate to one or more of the various figures. An example computing environment with an application connector (e.g., as installed at a client device) configured to perform disaster recovery (DR) configuration functions, as well as a compute service manager with a disaster recovery manager (DRM) (e.g., configured to generate an FG with one or more RGs and perform disclosed DR-related functionalities) are discussed in connection with FIGS. 1-3. Example multi-deployment arrangements using replication groups are discussed in connection with FIG. 4 and FIG. 5. Data sharing configurations are discussed in connection with FIG. 6. Additional database system arrangements using replication groups for failover and sharing are discussed in connection with FIG. 7-FIG. 9. Example replication group configurations and usages are discussed in connection with FIG. 10-FIG. 18. Example configurations associated with DR for data sharing are discussed in connection with FIG. 19-FIG. 26. A more detailed discussion of example computing devices that may be used with the disclosed techniques is provided in connection with FIG. 27.

FIG. 1 illustrates an example computing environment 100 that includes a network-based database system 102 with a DRM 132, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some aspects, the computing environment 100 may include a cloud computing platform 101 with the network-based database system 102, and a storage platform 104 (also referred to as a cloud storage platform). The cloud computing platform 101 provides computing resources and storage resources that may be acquired (purchased) or leased and configured to execute applications and store data.

The cloud computing platform 101 may host a cloud computing service 103 that facilitates storage of data on the cloud computing platform 101 (e.g., data management and access) and analysis functions (e.g. SQL queries, analysis), as well as other processing capabilities (e.g., configuring FGs and RGs as described herein). The cloud computing platform 101 may include a three-tier architecture: data storage (e.g., storage platforms 104 and 122), an execution platform 110 (e.g., providing query processing), and a compute service manager 108 providing cloud services.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the cloud storage platforms 104 and 122 (e.g., AWS®, Microsoft Azure Blob Storage®, or Google Cloud Storage). The network-based database system 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services to multiple client accounts.

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the network-based database system 102. A user may utilize the client device 114 to submit data storage, retrieval, and analysis requests to the compute service manager 108. Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client device (or devices) 114 operated by such users. For example, notification to a user may be understood to be a notification transmitted to client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some embodiments, the client device 114 is configured with an application connector 128, which may be configured to perform DR configuration functions 130. For example, client device 114 can be associated with a data provider using the cloud computing service 103 of the network-based database system 102. In some embodiments, DR configuration functions 130 include generating a DR request 138 for communication to the network-based database system 102 via the network 106. For example, DR request 138 can be communicated to the DRM 132 of the compute service manager 108. The DRM 132 is configured to generate an FG 136 that includes at least one RG (e.g., RG 134) based on the DR request 138.

In some embodiments, a manifest of the RG 134 indicates a plurality of account objects for replication. In some aspects, the plurality of account objects can be associated with a corresponding plurality of account object types. In some aspects, the plurality of account object types comprises at least one of the following: a users account object type, a roles account object type, a warehouse object type, a resource monitor object type, a database account object type, a share account object type, an integration account object type, and network policies account object type.

In some embodiments, a users account object of the users account object type lists users authorized to access at least one target account (e.g., an account of a data provider or data consumer 115). In some embodiments, a roles account object of the roles account object type configures privileges for the users to access the at least one target account. In some aspects, a warehouse object of the warehouse object type indicates compute resources (e.g., at least one virtual warehouse of the execution platform 110) for executing a workload associated with one or more databases of the data provider. In some embodiments, a resource monitor object of the resource monitor object type configures monitoring usage of the compute resources.

In some aspects, a database account object of the database account object type indicates one or more databases of the data provider. In some embodiments, the replication group configuration functions 130 also includes generating the replication request to further include the database account object and a list of at least one allowed database. The at least one allowed database can be a subset of the one or more databases of the data provider.

In some embodiments, a share account object (also referred to as a share or a share object) of the share account object type is an object that encapsulates information used for sharing a database. A share may include: (a) privileges that grant access to the database and the schema containing the objects to share; (b) the privileges that grant access to the specific objects in the database; and (c) the consumer accounts with which the database and its objects are shared. Once a database is created (e.g., in a consumer account) from a share, all the shared objects are accessible to users in the consumer account.

In some embodiments, an integration account object (also referred to as an application programming interface (API) integration) of the integration account object type is used to store information about a proxy service (e.g., Hypertext Transfer Protocol Secure, or HTTPS, proxy service), including the following information: (a) the cloud platform provider (e.g., Amazon AWS); (b) the type of proxy service (in case the cloud platform provider offers more than one type of proxy service); (c) the identifier and access credentials for a cloud platform role that has sufficient privileges to use the proxy service (for example, on AWS, the role's ARN (Amazon resource name) serves as the identifier and access credentials; when this cloud user is granted appropriate privileges, this user can be to access resources on the proxy service (an instance of the cloud platform's native HTTPS proxy service, for example, an instance of an Amazon API Gateway)); (d) an API integration object also specifies allowed (and optionally blocked) endpoints and resources on those proxy services.

In some embodiments, a network policy object of the network policies account object type provides options for managing network configurations in a network-based database system. A network policy object can be used to restrict access to an account based on the user's IP address. Effectively, a network policy enables creating an IP allowed list, as well as an IP blocked list, if desired. In this regard, account-level network policy management can be performed through a web interface or SQL.

In some embodiments, the DR configuration functions 130 also include generating a replication request (e.g., FG replication and/or RG replication) that includes scheduling information. The DRM 132 can use the scheduling information to configure a replication schedule and perform replication of one or more objects specified by the manifest based on the replication schedule.

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device. In some embodiments, metadata database 112 is configured to store account object metadata (e.g., account objects used in connection with an RG).

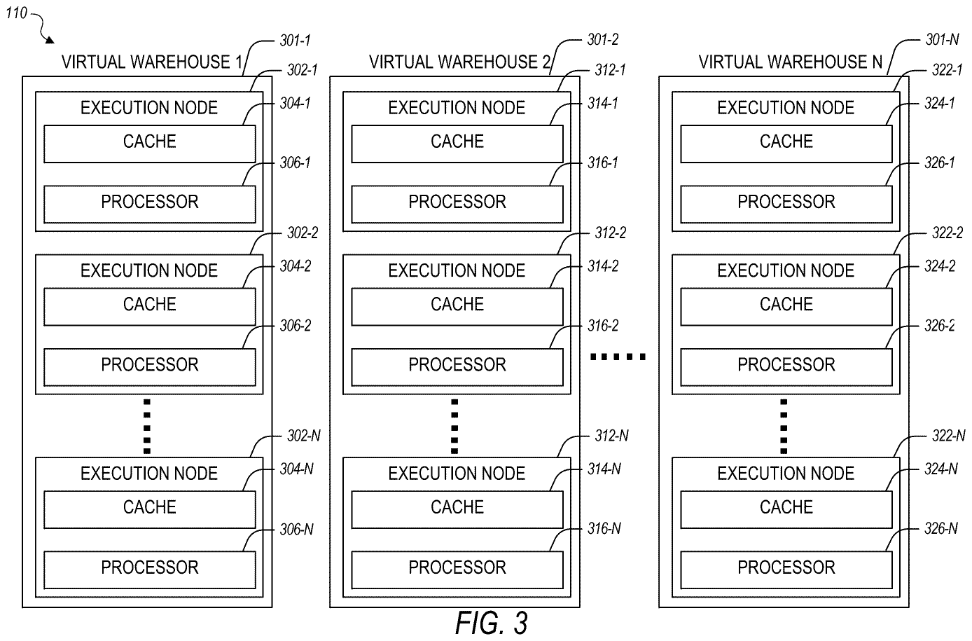

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud storage platform 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data storage technology. Additionally, the cloud storage platform 104 may include distributed file systems (such as Hadoop Distributed File Systems (HDFs)), object storage systems, and the like. In some embodiments, at least one internal stage 126 may reside on one or more of the data storage devices 120-1-120-N, and at least one external stage 124 may reside on the cloud storage platform 122.

In some embodiments, the compute service manager 108 includes a DRM 132. The DRM 132 comprises suitable circuitry, interfaces, logic, and/or code and is configured to perform the disclosed DR-related functionalities associated with the configuration and use of FGs and RGs in connection with disaster recovery for data sharing. For example, the DRM 132 generates an FG 136 based on the DR request 138. DRM 132 can also configure one or more RGs (e.g., RG 134) to be part of (or within) FG 136, which allows for disaster recovery and data sharing. In some aspects, RG 134 can include a manifest, which lists a plurality of account objects for replication. The DRM 132 is also configured to perform a replication of the plurality of account objects from a source account of the data provider into at least one target account based on the manifest of the RG. For example, DRM 132 replicates different account objects (which can include a database account object or other types of account objects) to one or more designated target accounts at a predefined schedule based on the contents of the manifest of the RG 134. In this regard, RG 134 can be used for grouping databases and account objects that can be replicated as a single unit. Such replication reduces the complexity in managing DR scenarios and facilitates automated scheduled refreshes. Additionally, FG 136 allows for the replication of multiple databases together in a transactionally consistent manner, with dependent objects between databases. Additional functionalities associated with the configuration of FGs and RGs are discussed in connection with FIG. 4-FIG. 26.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

The compute service manager 108, metadata database(s) 112, execution platform 110, and storage platform 104, are shown in FIG. 1 as individual discrete components. However, each of the compute service manager 108, metadata database(s) 112, execution platform 110, and storage platform 104 may be implemented as a distributed system (e.g., distributed across multiple systems/platforms at multiple geographic locations). Additionally, each of the compute service manager 108, metadata database(s) 112, execution platform 110, and storage platform 104 can be scaled up or down (independently of one another) depending on changes to the requests received and the changing needs of the network-based database system 102. Thus, in the described embodiments, the network-based database system 102 is dynamic and supports regular changes to meet the current data processing needs.

During a typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

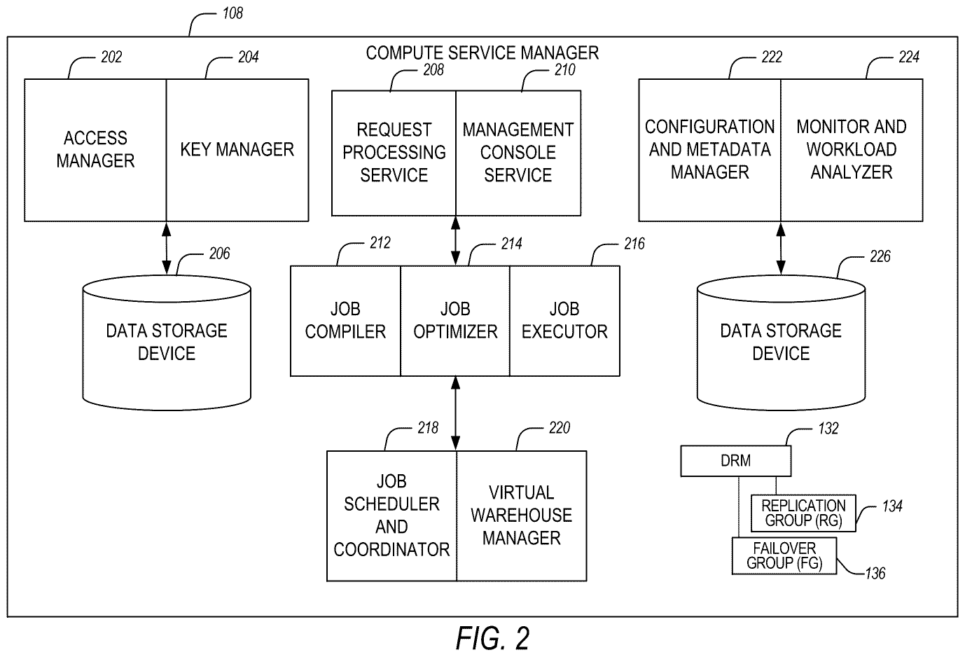

FIG. 2 is a block diagram illustrating components of the compute service manager 108, in accordance with some embodiments of the present disclosure. As shown in FIG. 2, the compute service manager 108 includes an access manager 202 and a credential management system (or key manager) 204 coupled to an access metadata database 206, which is an example of the metadata database(s) 112. Access manager 202 handles authentication and authorization tasks for the systems described herein. The credential management system 204 facilitates the use of remotely stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes a configuration and metadata manager 222, which manages the information related to the data stored in the remote data storage devices and the local buffers (e.g., the buffers in execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1 may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

As previously mentioned, the compute service manager 108 includes the DRM 132 configured to perform the disclosed DR-related functionalities associated with the configuration and use of FGs and RGs for DR. For example, the DRM 132 can generate an FG 136 that includes RG 134 based on the DR request 138.

FIG. 3 is a block diagram illustrating components of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

In some embodiments, at least one of the execution nodes of execution platform 110 (e.g., execution node 302-1) can be configured with the replication group manager 132.

Some example embodiments involve provisioning a remote account of a data provider—a type of account that is referred to herein at times as a “remote-deployment account,” a “remote-deployment account of a data provider,” a “data-provider remote account,” and the like—with one or more FGs and RGs for purposes of performing data sharing and DR (e.g., replication from a source account into a target account and then failover to the target account in case of a failover event).

It is also noted here that the terms “replication” and “refresh” (and similar forms such as “replicating,” “refreshing,” etc.) are used throughout the present disclosure. Generally speaking, “refresh” and its various forms are used to refer to a command or instruction that causes a database to start receiving one-way syncing (e.g., “pushed” updates). The term “replicate” and its various forms are used in a few different ways. In some cases, the “replicate” terms are used as a precursor to the “refresh” terms, where the “replicate” terms refer to the preparatory provisioning (populating, storing, etc.) of account objects, in some cases along with one or task objects as described herein. When used in that manner, the “replicate” terms can be analogized to putting up scaffolding for a building, and the “refresh” terms can be analogized to putting up the building.

The “replicate” terms are also used in another way herein—in those cases, the terms are used as a general label for what a data consumer may request (e.g., via their data provider) when the data consumer wishes to have made available to them a local instance of a given database at a given remote-deployment account of their data provider. That is, the data consumer may request “replication” of a given database to a given remote deployment, and a data platform may responsively perform operations such as the more technical “replicate” operations (putting up the scaffolding) using one or more RGs and “refresh” operations (building, populating, filling in, etc.) that are also described herein.

FIG. 4 illustrates an example regional-deployment map 400 for the example database system of FIG. 1, in accordance with some embodiments of the present disclosure. The regional-deployment map 400 is presented purely by way of example and not limitation, as different numbers and/or boundaries of regions could be demarcated in different implementations. As can be seen in FIG. 4, the regional-deployment map 400 includes three example geographic regions: North American region 402, European region 404, and Asia Pacific region 406. Moreover, various instances of deployments of the network-based database system 102 (also referred as “deployments”) are depicted on the regional-deployment map 400. A legend 408 shows symbols used for three different deployments of the network-based database system 102, including deployments that are hosted by the cloud-storage platform 122A, deployments hosted by the cloud-storage platform 122B, and deployments that are hosted by the cloud-storage platform 122C. Cloud-storage platforms 122A, 122B, and 122C can be collectively referred to as cloud-storage platform 122, which are also illustrated in FIG. 1.

In some embodiments, FGs and RGs configured based on the disclosed techniques can be used in disaster recovery (DR) and global data sharing use cases associated with source accounts (e.g., accounts of a data provider) and target accounts (e.g., accounts of a data provider or a dealer consumer) located in different deployments.

FIG. 5 illustrates diagram 500 of an example global object in a primary deployment, which is accessible at other deployments, in accordance with some embodiments of the present disclosure. Referring to FIG. 5, an entity object 510 is used to generate a global object 512 in deployment 502 (e.g., a primary deployment or a source deployment). In some aspects, DRM 132 can configure an RG to replicate global object 512 as global objects 514, 516, . . . , 518 in corresponding deployments (e.g., secondary deployments or target deployments) 504, 506, . . . , 508. In some aspects, the global object 512 can be modified only in the source deployment 502, while the global objects 514-518 in the corresponding target deployments 504-508 are read-only.

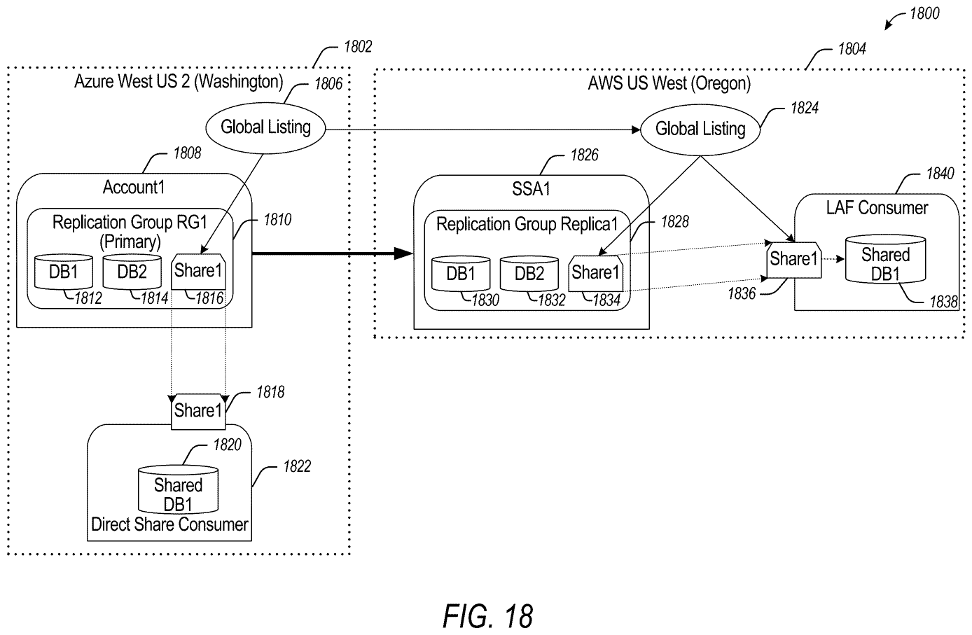

FIG. 6 is a diagram 600 of sharing data between two accounts in the same deployment using a direct share, in accordance with some embodiments of the present disclosure. Referring to FIG. 6, deployment 602 includes user accounts 604 and 606. User account 604 is configured with share object 612 (also referred to as direct share or share) and databases 608 and 610. User account 606 is configured with share object 614 and database 616. In some aspects, share objects 612 and 614 are used to share databases 608 and 610 into database 616. For example, databases 608 and 610 and share object 612 can be configured as an RG so that data sharing from account 604 to account 606 can be performed. Additional data-sharing configurations (e.g., via LAF) are discussed in connection with FIG. 18.

FIG. 7 illustrates diagram 700 of example RGs specifying different account objects, in accordance with some embodiments of the present disclosure.

As mentioned above, an RG can include account-entity domains such as users, roles, warehouses, databases, etc., and optionally include/exclude certain account domains, and also specific databases, schemas, and tables. This enables a near-zero knob experience for simple use cases for data providers or data consumers who want to replicate their entire account and also enables advanced use cases such as filtering out certain databases, schemas, and tables for cost control, or independent replication/failover for databases that belong to different business units of a data provider or a data consumer.

Referring to FIG. 7, the DRM 132 can configure a first RG 702 and a second RG 704. RG 702 includes users account objects U1 and U2 associated with corresponding roles account objects R1 and R2. Roles account objects R1 and R2 with additional roles account objects R3, R4, and R5. Roles R4 and R5 are associated with databases DB1 and DB2 as well as virtual warehouse VW1 via different grants. Since DB1 and DB2 have cross-database references (or database dependencies), both databases are included in the same RG. Roles R1-R5, databases DB1, DB2, and virtual warehouse VW1 are associated with grants G1, G2, G3, G4, G7, G8, G9, and G10 (as illustrated in FIG. 7). In some embodiments, database dependencies can be verified upon a refresh command and a notification can be provided to the client device communicating the replication request.

RG 704 includes database DB3 which is associated with roles R3 and R4 via grants G5 and G6.

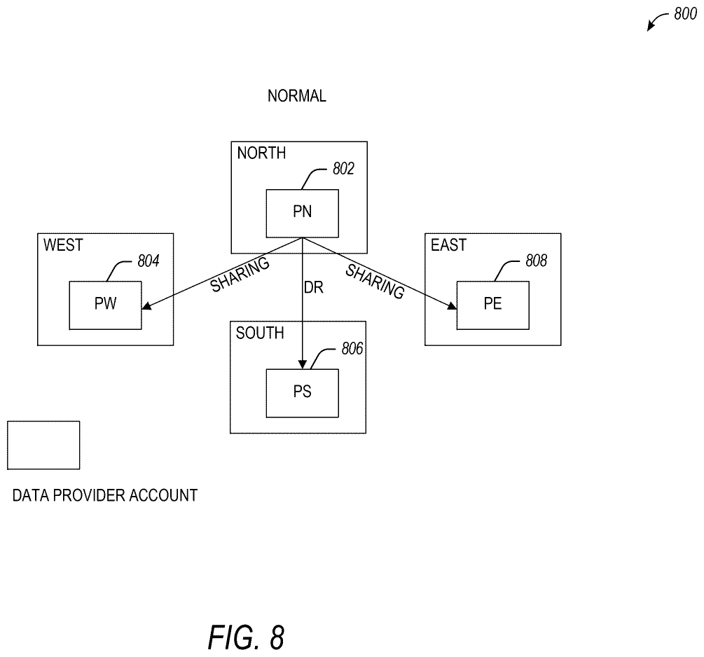

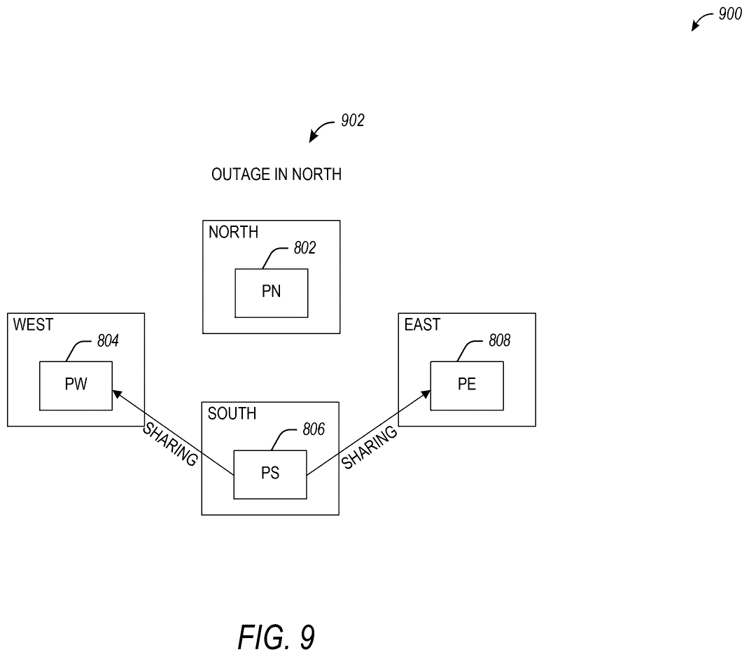

FIG. 8 and FIG. 9 illustrate example RG usage scenarios in connection with DR and data sharing, in accordance with some embodiments of the present disclosure. Referring to FIG. 8, use case 800 illustrates a replication of account objects using RGs from a source (or primary) account 802 of a data provider into other data provider accounts 804, 806, and 808, with all accounts being deployed at different geographic locations. For example, an RG from the source account 802 can be configured as an FG and replicated to target account 806. In the event of a detected network failure event, DR can be initiated by promoting the target account 806 to a primary account (an example DR configuration is illustrated in FIG. 9). As illustrated in FIG. 8, account objects replication from the source account 802 to target accounts 804 and 808 is used for global data sharing and generating read replicas of account objects using the RG. The RG used for data object replication from source account 802 to target account 806 can be configured as an FG so that target account 806 can be promoted to a primary/source account in the event of a DR, which is illustrated in FIG. 9.

FIG. 9 illustrates a DR event 900 where a network outage is detected in the North location 902 where source account 802 is deployed. Since account 802 was previously replicated using an FG into account 806, account 806 can be promoted to a primary/source account which can initiate account object replication using RGs into accounts 804 and 808 for purposes of global data sharing.

In some embodiments, an FG can be failed over to other accounts for DR. An RG can be configured as an FG by setting a FAILOVER_ALLOWED_TO_ACCOUNTS property in the manifest of the RG. In some aspects, zero or more FGs can be created for an account. An example manifest of an RG configured as FG is illustrated in Table 1 below.

TABLE 1
CREATE [OR REPLACE] REPLICATION GROUP [IF NOT EXISTS] <name>
INCLUDE { objectTypes | ALL [ OBJECTS ] }
[ ALLOWED_DATABASES = (<database>, <database>, .. ) ]
[ REPLICATION_ALLOWED_TO_ACCOUNTS = (<account>, <account>)]
[ FAILOVER_ALLOWED_TO_ACCOUNTS = (<account>, <account>)]
[ SCHEDULE = ‘ <num> MINUTE ’ ]
[ COMMENT = ′<string_literal>′]

In other embodiments, an RG can be configured as an FG by calling the SQL command CREATE FAILOVER GROUP, which is discussed herein below.

In some aspects, the RGs used for replicating data objects for data sharing into accounts 804 and 808 can enable read workloads in such accounts and may not be failed over. An example manifest of an RG used for global data sharing is illustrated in Table 2 below.

TABLE 2
CREATE [OR REPLACE] REPLICATION GROUP [IF NOT EXISTS] <name>
INCLUDE { objectTypes | ALL [ OBJECTS ] }
[ ALLOWED_DATABASES = (<database>, <database>, .. ) ]
[ REPLICATION_ALLOWED_TO_ACCOUNTS = (<account>, <account>)]
[ SCHEDULE = ‘ <num> MINUTE ’ ]
[ COMMENT = ′<string_literal>′]

In some embodiments, database replication based on RGs can be used for DR scenarios for data sharing. For DR, a main (or primary) deployment region can fail over to a new deployment region that runs all the workloads of the main region (where the workloads of the main region can be replicated into the new deployment region using FGs). The new deployment region can be promoted to a primary region, and workloads, as well as data sharing, can be executed from the primary region. For an FG, the account specified in the manifest is allowed for promotion from a secondary to a primary account designation. For an RG, the specified account is allowed only for a secondary account designation and cannot be used for failover.

In example embodiments, the following configurations may be used in connection with FGs. An example command that configures an RG as a member of an FG is illustrated in Table 3 below.

TABLE 3
CREATE FAILOVER GROUP [ IF NOT EXISTS ] <name>
OBJECT_TYPES = REPLICATION GROUPS, LISTINGS, [Other Object
Types]
[ ALLOWED_LISTINGS = <listing_name> [ , <listing_name , ... ] ]
[ ALLOWED_REPLICATION_GROUPS = <replication_group> [ ,
<replication_group , ... ] ]
[ ALLOWED_DATABASES = <db_name> [ , <db_name> , ... ] ]
[ ALLOWED_SHARES = <share_name> [ , <share_name> , ... ] ]
[ ALLOWED_INTEGRATION_TYPES = <integration_type_name> [ ,
<integration_type_name> , ... ] ]
ALLOWED_ACCOUNTS = <org_name>.<target_account_name> [ ,
<org_name>.<target_account_name> , ... ]
[ IGNORE EDITION CHECK ]
[ REPLICATION_SCHEDULE = ′{ <num> MINUTE | USING CRON <expr>
<time_zone>

An example manifest of an RG configured as a FG in a target account is illustrated in Table 4 below.

TABLE 4

CREATE FAILOVER GROUP MyFG
AS REPLICA OF MyORG.MyAccount1.MyFG;

The above configuration also brings any sub-RG along.

In some embodiments, the following SQL command can be used to list available FGs:
SHOW [FAILOVER] REPLICATION GROUPS [IN<account> ACCOUNT].

In some embodiments, the following SQL command can be used for refreshing a secondary FG in a target account:
ALTER FAILOVER GROUP [IF EXISTS] FG1 REFRESH.

In some embodiments, the following SQL command can be used for failing over an FG:
ALTER FAILOVER GROUP [IF EXISTS] FG1 PRIMARY.

In some embodiments, the following SQL command can be used for altering an FG by adding an account:
ALTER FAILOVER GROUP [IF EXISTS] RG1
ADD [ORG.]ACCT3 TO ALLOWED_ACCOUNTS.

In some embodiments, the following SQL command can be used for altering an FG by removing an account:
ALTER FAILOVER GROUP [IF EXISTS] RG1
REMOVE [ORG.] ACCT2 FROM ALLOWED_ACCOUNTS.

In some embodiments, the following SQL command can be used for dropping a primary or a secondary FG:
DROP FAILOVER GROUP [IF EXISTS] RG1.

In some embodiments, the following SQL commands in Table 5 can be used for the task of refreshing a secondary failover group on a target account:

TABLE 5

USE DATABASE UTIL_DB;
CREATE TASK RG_REFRESH
WAREHOUSE = PROD_WH
SCHEDULE = 15 MINUTE
AS
ALTER FAILOVER GROUP RG1 REFRESH;

In some embodiments, the example manifest in Table 6 can be used to create an FG for multi-database replication.

TABLE 6

CREATE FAILOVER GROUP [IF NOT EXISTS] RG1
OBJECT_TYPES = USERS, ROLES
, WAREHOUSES
, RESOURCE MONITORS
, DATABASES
[ ALLOWED_DATABASES = DB1 ]
ALLOWED_ACCOUNTS = ORG.ACCT2

In aspects when OBJECT_TYPES=ALL, the manifest specifies and includes all available objects. However, the objects can be filtered by specifying a specific database in the manifest of the RG (e.g., specifying ALLOWED_DATABASES=DB1 which indicates that the object types only from database DB1 can be used for data replication).

In some embodiments, the example manifest in Table 7 can be used to create a primary FG for multi-database replication.

TABLE 7

CREATE FAILOVER GROUP RG2
OBJECT_TYPES = DATABASES
ALLOWED_DATABASES = DB2, DB3
ALLOWED_ACCOUNTS = ORG.ACCT2

In some embodiments, the example manifests in Table 8 can be used to create multiple FGs for multi-database replication.

TABLE 8

CREATE FAILOVER GROUP [IF NOT EXISTS] RG1
OBJECT_TYPES = USERS, ROLES
, WAREHOUSES
, RESOURCE MONITORS
, DATABASES
ALLOWED_DATABASES = DB1
ALLOWED_ACCOUNTS = ORG.ACCT2
ALLOWED_ACCOUNTS = ORG.ACCT2
CREATE FAILOVER GROUP [IF NOT EXISTS] RG2
OBJECT_TYPES = DATABASES
ALLOWED_DATABASES = DB2, DB3
ALLOWED_ACCOUNTS = ORG.ACCT2
ALLOWED_ACCOUNTS = ORG.ACCT2

In some embodiments, the example manifest in Table 9 can be used to create a linked secondary FG for multi-database replication on a target account.

TABLE 9

CREATE FAILOVER GROUP [IF NOT EXISTS]
AS REPLICA OF [ORG.]ACCT1.RG1;

In some embodiments, the following SQL command can be used for refreshing a secondary FG:
ALTER FAILOVER GROUP [IF EXISTS] RG1 REFRESH.

In some embodiments, the following SQL commands can be used for altering a primary FG to remove all databases:
ALTER FAILOVER GROUP FG1

$$SET ALLOWED\_DATABASES = NULL .$$

In some embodiments, the following SQL commands can be used for altering a primary FG to move databases or shares across groups atomically:
ALTER FAILOVER GROUP FG1
MOVE DATABASES DB1 TO FAILOVER GROUP FG2.

In some embodiments, a manifest of an RG can include scheduling information that can be used to perform the replication of account objects specified in the manifest according to a replication schedule.

In some embodiments, to create a primary FG with a replication schedule, the following configurations for the scheduling information in the manifest can be used: (a) Support number of minutes; (b) Support cron expression and time zone (e.g., the same subset of standard cron); (c) Next refresh fails is skipped if the previous one is still running; (d) Next refresh will be scheduled as the later of (next scheduled time, when the current refresh finishes); and (e) Failover fails if a refresh is still running.

In some embodiments, the example manifests in Table 10 can be used to create a primary FG with a replication schedule.

TABLE 10

CREATE FAILOVER GROUP [IF NOT EXISTS] RG1
OBJECT_TYPES = USERS, ROLES, WAREHOUSES, RESOURCE
MONITORS,
DATABASES
ALLOWED_DATABASES = DB1
ALLOWED_ACCOUNTS = ORG.ACCT2
REPLICATION_SCHEDULE = ‘60 MINUTE’
CREATE FAILOVER GROUP [IF NOT EXISTS] RG1
INCLUDE USERS, ROLES, WAREHOUSES, RESOURCE MONITORS,
DATABASES
ALLOWED_DATABASES = DB1
ALLOWED_ACCOUNTS = ORG.ACCT2
REPLICATION_SCHEDULE = ′USING CRON 0 9-17 * * SUN
America/Los_Angeles′

In some embodiments, the following SQL command can be used for suspending replication to enable a graceful failover:
ALTER FAILOVER GROUP RG1 SUSPEND.

In some embodiments, the following SQL command can be used for resuming replication to enable a graceful failover:
ALTER FAILOVER GROUP RG1 RESUME.

In some embodiments, the following SQL command can be used for altering a replication schedule for a group:
ALTER FAILOVER GROUPS [IF NOT EXISTS] RG1 SET

$$REPLICATION\_SCHEDULE = ‘ 5 MINUTE ’ .$$

FIG. 10-FIG. 17 illustrate example RG configurations and usages, in accordance with some embodiments of the present disclosure.

Referring to FIG. 10, there is illustrated a use case scenario 1000 where an FG 1002 in account A of data provider 1 (DP1) is replicated as FG 1004 in account B of data consumer 1 (DC1). As illustrated in FIG. 10, roles and privileges associated with FG 1002 are replicated as corresponding roles and privileges associated with FG 1004 to achieve consistent role-based access control across replicas.

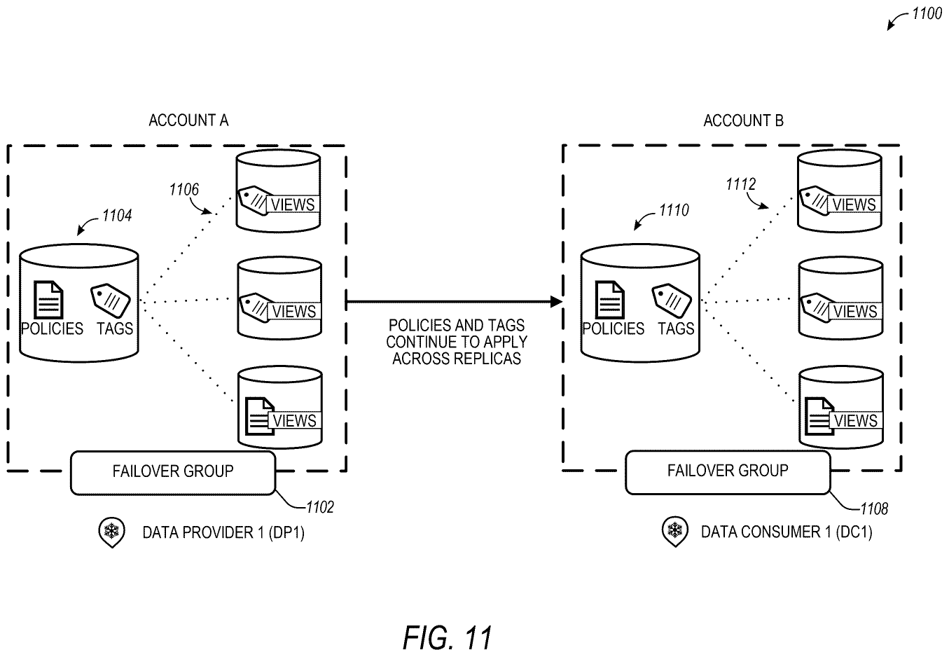

Referring to FIG. 11, a use case scenario 1100 is illustrated, where an FG 1102 in account A of DP1 is replicated as FG 1108 in account B of DC1. As illustrated in FIG. 11, the manifest of FG 1102 specifies database 1104, which includes policies (e.g., masking, row access, or other policies) and tags. The tags are applied to multiple views 1106 in other databases. In some embodiments, the manifest of FG 1102 will include database 1104 as well as the related databases associated with views 1106. In this regard, the replicated FG 1108 would also include a manifest specifying corresponding databases 1110 as well as databases corresponding to views 1112 so that the policies and tags continue to apply across replicas.

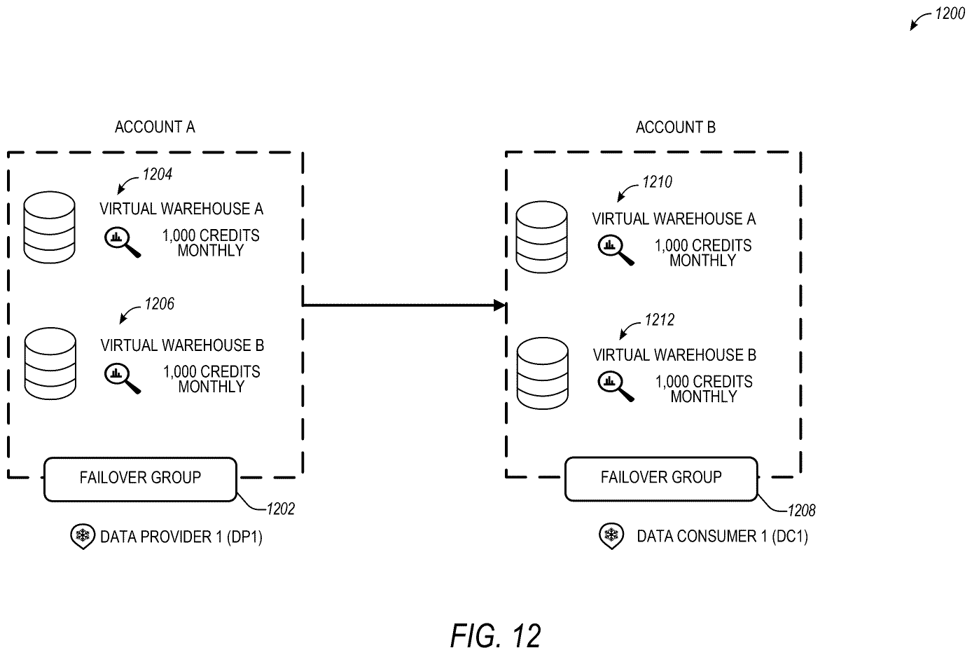

Referring to FIG. 12, a use case scenario 1200 is illustrated where an FG 1202 in account A of DP1 is replicated as FG 1208 in account B of DC1. As illustrated in FIG. 12, the manifest of FG 1202 includes warehouse objects 1204 and 1206 with corresponding resource monitoring objects, which are replicated as warehouse objects 1210 and 1212 in FG 1208. In some embodiments, the virtual warehouses specified by the warehouse objects are replicated in a suspended state the very first time and can be resumed when needed. The resource monitors are also replicated and can be configured to continue to govern the consumption of compute resources on the secondary accounts (e.g., account B) of DC1.

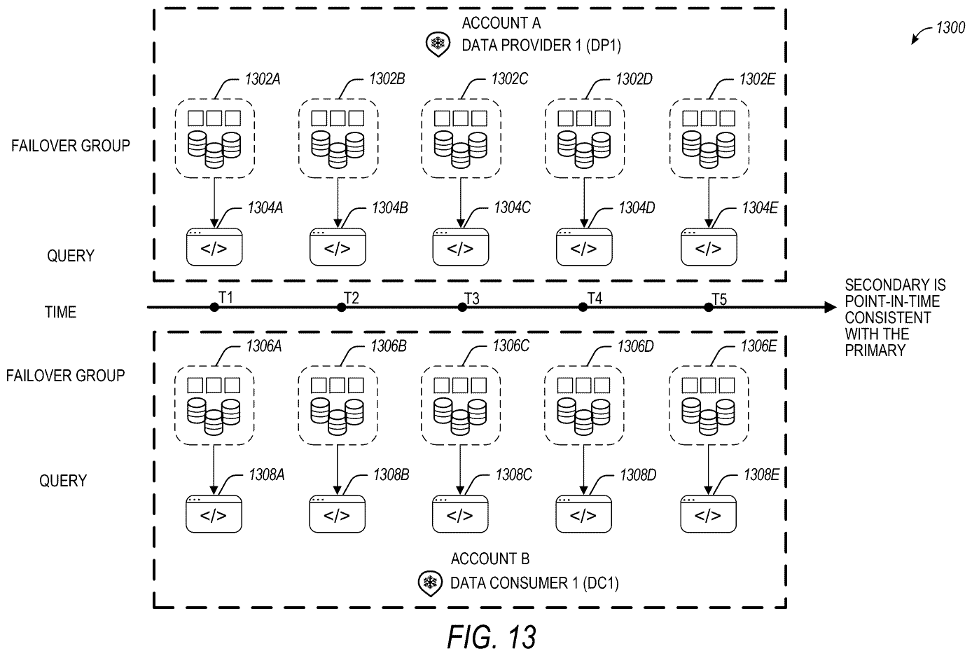

Referring to FIG. 13, there is illustrated a use case scenario 1300 where FGs 1302A-1302E associated with corresponding queries 1304A-1304E in account A of DP1 are replicated at corresponding time instances T1-T5 as corresponding FGs 1306A-1306E associated with corresponding queries 1308A-1308E in account B of DC1. In this regard, query results obtained in the secondary account (e.g., account B) are point-in-time consistent with query results obtained in the primary account (e.g., account A).

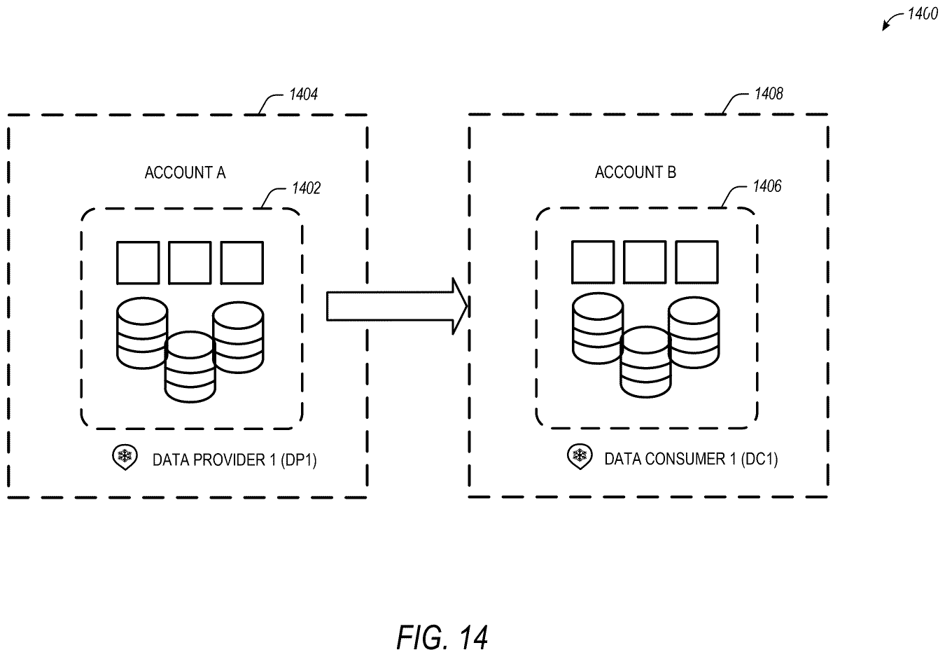

Referring to FIG. 14, a use case scenario 1400 is illustrated where an RG 1402 in account 1404 of DP1 is replicated as an RG 1406 in account 1408 of DC1. In some embodiments, the replication is performed on a schedule without a need to create and manage individual replication tasks.

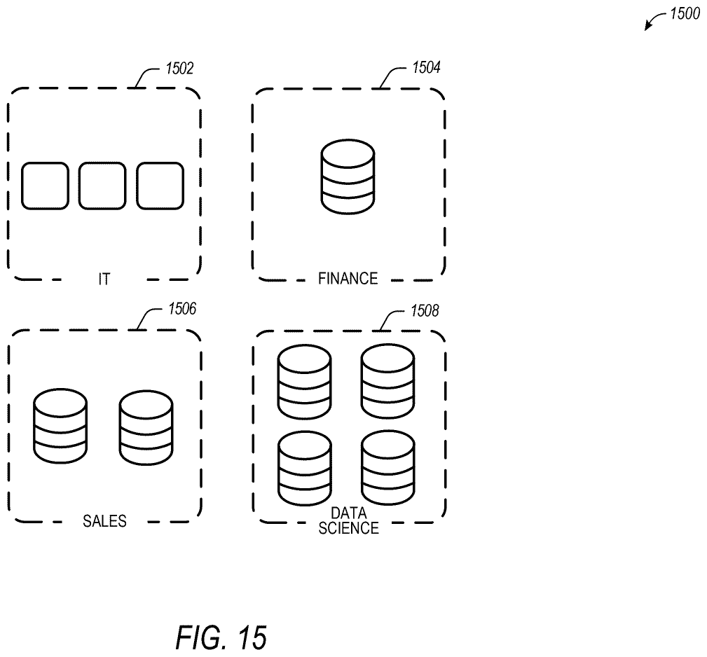

Referring to FIG. 15, there is illustrated a use case scenario 1500 where account objects from a single RG (e.g., such as RG 1402 in FIG. 14) can be grouped in separate RGs 1502, 1504, 1506, and 1508 for flexibility. For example, account objects associated with different business units of a data provider or a data consumer (e.g., IT, finance, sales, and data science) can be grouped into the corresponding separate RGs 1502-1508.

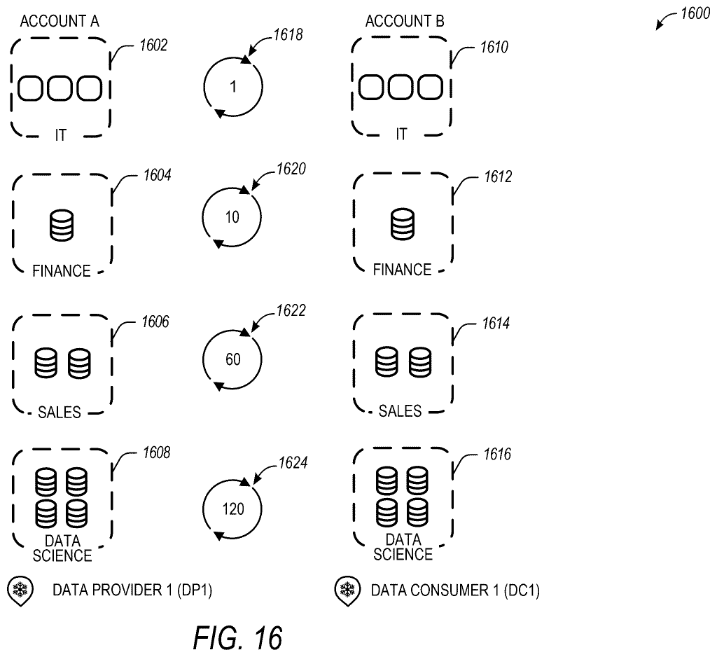

Referring to FIG. 16, there is illustrated a use case scenario 1600 where RGs 1602, 1604, 1606, and 1608 are replicated from account A of DP1 to corresponding RGs 1610, 1612, 1614, and 1616 in account B of DC1. Additionally, the manifests of RGs 1602, 1604, 1606, and 1608 are configured to specify corresponding scheduling information 1618, 1620, 1622, and 1624 for setting individual replication schedules for each of the RGs 1602-1608.

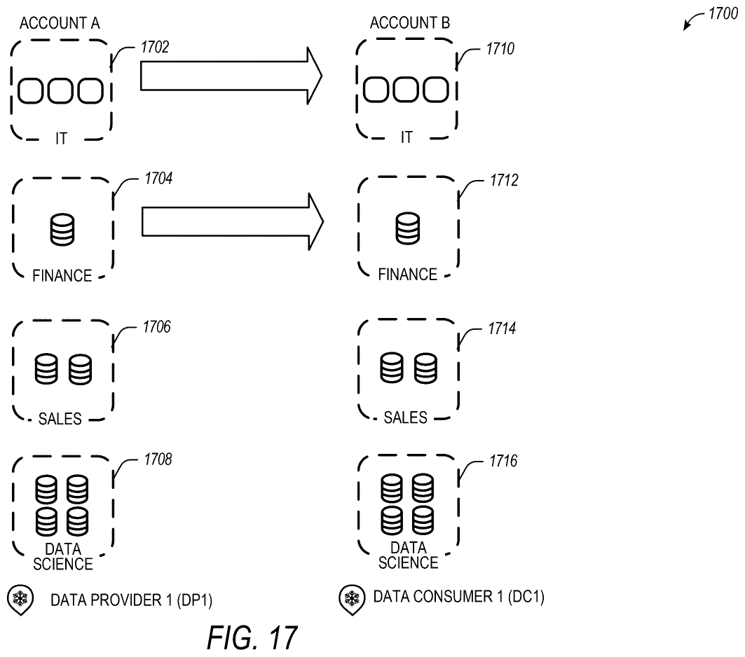

Referring to FIG. 17, there is illustrated a use case scenario 1700 where FGs 1702, 1704, 1706, and 1708 are replicated from account A of DP1 to corresponding FGs 1710, 1712, 1714, and 1716 in account B of DC1. In some embodiments, multiple failovers from account A to account B using one or more of the FGs 1710, 1712, 1714, and 1716 can take place separately, on-demand, or at a predefined schedule (e.g., FIG. 17 illustrates failover using only FGs 1710 and 1712).

FIG. 18 is a diagram 1800 of a listing auto fulfillment (LAF) using a replication group replica, in accordance with some embodiments of the present disclosure. Referring to FIG. 18, LAF can be configured for sharing of data within a deployment and between deployments 1802 and 1804. For example, global listing 1806 can be a listing in a data marketplace and can be configured at deployment 1802. Metadata of global listing 1806 can be used for sharing data (e.g., databases 1812 and 1814) from RG 1810 of account 1808 into database 1820 of account 1822 using shares 1816 and 1818.

In some aspects, data sharing can be configured between deployments 1802 and 1804 (e.g., cross-region data sharing). For example, global listing 1824 (corresponding to global listing 1806) is configured at deployment 1804. Additionally, DRM 132 configures a secure share area (SSA) 1826 within deployment 1804. In some aspects, the SSA can be configured as a hidden account that is not discoverable or accessible by users (except it can be discoverable and accessible by the DRM). SSA 1826 can be configured so that RG 1810 is replicated as RG 1828 in SSA 1826, with RG 1828 including databases 1830 and 1832 (corresponding to databases 1812 and 1814) and share 1834 (corresponding to share 1816). Share 1834 and share 1836 (in LAF consumer account 1840) are then used for sharing databases 1830 and 1832 to shared database 1838 in the LAF consumer account 1840. In this regard, consumers can use direct shares (e.g., shares 1834 and 1836) in the target region (deployment 1804) to get to this data as if the provider (e.g., owner of account 1808 in deployment 1802) were present locally at deployment 1804.

In some aspects, DRM 132 can configure data sharing via manual replication (e.g., using RGs and shares). In some aspects, DRM 132 can configure RGs to replicate across different cloud regions and share data sets with clients of the network-based database system 102.

In some aspects, FGs can be used to replicate objects for disaster recovery and failover to another region in case of outages. When an outage occurs (e.g., a failover event) in the provider's primary region (deployment), the provider can fail over to the DR region via the FG and perform the following:
(a) Continue fulfilling consumers (e.g., fulfilling data replication and sharing) without any downtime;
(b) Add/remove databases and target regions to the replication group that is fulfilling data sharing for existing consumers; and
(c) Data/Native app sharing via listings (e.g., using LAF as explained above).

In some aspects, LAF can be used to provision behind-the-scenes RGs on behalf of the customer. In cases of an outage to the provider's primary region, the provider can fail over the objects as well as listing to the secondary region such that:
(a) Consumers of the existing listing can continue to be fulfilled from the DR region; and
(b) Providers can modify the listing from the DR account and fulfill new requests from the consumers.

In some aspects, DRM 132 can configure DR-based functionalities using the following configurations:
(a) An object (any data object that can be included in a replication group) can be both replicated to a set of target accounts for data sharing (e.g., via an RG) and replicated to another set (or the same set) of target accounts for disaster recovery (e.g., via an FG that overlaps with the RG).
(b) During an outage when a failover event occurs, consumers (clients of the data provider) of that object get the latest version from the newly promoted primary on a subsequent refresh.
(c) For non-LAF data sharing scenarios, after failing over to the DR region (e.g., promoting an FG replica to a primary FG), providers can add/remove new target regions to share the object.
(d) For LAF-based data-sharing scenarios, providers can fail over their listing to their DR region, allowing them to alter the listings and fulfill new data-sharing requests.

FIG. 19 is a diagram of a failover group 1900, including overlapping replication groups, in accordance with some embodiments of the present disclosure. Referring to FIG. 19, FG 1900 is configured as a primary FG of a provider. FG 1900 includes database (DB) 1902 and RG 1904. As illustrated in FIG. 19, RG 1904 can be configured as a nested RG. More specifically, RG 1904 includes RG 1906 (with DB 1910) and DB 1908. In this regard, FG 1900, RG 1904, and RG 1906 are configured as overlapping (or nested) groups as DB 1910 is associated with RG 1906, RG 1904, and FG 1900, and DB 1908 is associated with RG 1904 and FG 1900.

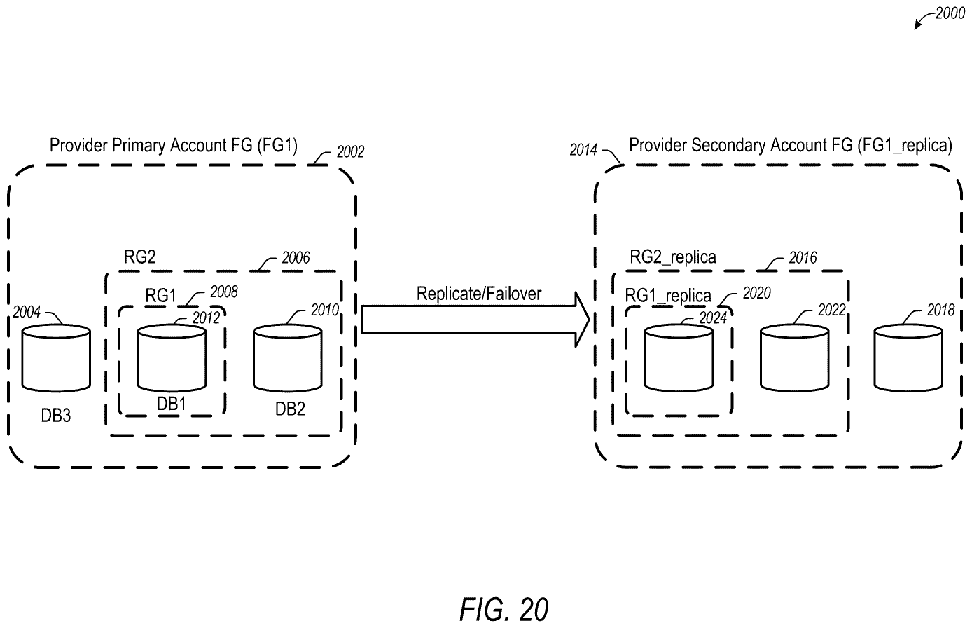

FIG. 20 is a diagram 2000 of generating a failover group replica during a failover event where the failover group replica includes overlapping replication groups, in accordance with some embodiments of the present disclosure. Referring to FIG. 20, FG 2002 is configured as the primary FG and includes DB 2004 and RG 2006. RG 2006 includes RG 2008 (with DB 2012) and DB 2010.

In some aspects, DRM 132 generates FG 2014 as a replica FG of the primary FG 2002. More specifically, FG 2014 includes RG 2016 (a replica of RG 2006) and DB 2018 (a replica of DB 2004). RG 2016 includes DB 2022 (a replica of DB 2010) and RG 2020 with DB 2024 (a replica of RG 2008 with DB 2012).

In some aspects, to configure the disclosed DR-related functions (e.g., DR for data sharing) using an overlapping FG and RGs, DRM 132 can use the following configurations:
(a) All objects in an RG (e.g., DBs, shares, etc.) are configured as a subset of a single FG. In this regard, when a failover occurs, all the consumers of the RGs will get a point-in-time consistent version of the objects from the DR region.

In some aspects, the association of the RG to the FG is tracked implicitly, and the user is not required to define this configuration. In some aspects, users can use the SHOW REPLICATION GROUP command to identify which FG the RG is associated with.

For example, suppose a provider defines an RG with DB1 and DB2 to be shared with Region X. In that case, they expect a point-in-time consistent version of both databases in Region X. If this constraint is not enforced, it would become possible for customers to define an FG_1 with DB1 that can independently fail over to Region 2 and another FG_2 with DB2 that can fail over to Region 3. This would prevent consumers in Region X from getting a point-in-time consistent version of both databases once either FG fails over. As a result of forcing objects of RG to be a complete subset of another FG, the primaries of the objects are guaranteed to be available in one account/region at a given point in time, which the consumer regions can fetch.
(b) In case the RG is a sub-database RG, all objects that are a part of an RG's ‘shares-with-dependencies’ closure must also be a part of the covering FG's closure.

While this is similar to configuration (a) above, it can be described here because, in sub-DB mode, a user could act such as changing grants on a share or changing a system tag in a DB successfully, but that has downstream effects where RG refresh fails. However, such a scenario may not be possible when operating in full-DB mode, as the CREATE or ALTER operations on RG/FG would fail if the constraints were not met.
(c) Such RGs are configured in the same target DR account(s) as present in the primary FG (this configuration is in addition to replicating to other regions where consumers may reside). In this regard, providers are able to fail over to their DR account and add new consumer regions by modifying their RGs.

For this configuration, no extra user action may be needed. For example, when constraint A is met, the replication service automatically manages (CREATEs/ALTERs/DROPs) RG replica on the DR account. This RG replica is visible to the customer via the SHOW REPLICATION GROUPS command, but customer action to drop/modify this RG replica is blocked. When the FG in the primary account (e.g., FG 2002) fails over to the FG in the secondary/target account (e.g., FG 2014), the RG (e.g., RG 2016) becomes primary, allowing the user to manage the RG.

For example, during a network outage, if the provider fails over DB1 to the DR account and operates from this new account for an extended period of time, they might get a request from new clients to make the DB1 available in new regions, which they may need to fulfill. If the RG is not present in the provider's DR account, they will not be able to fulfill new requests. Nor would there be a new primary RG after the failover occurs.

In some aspects, DRM 132 can configure showing implicit associations between FGs and RGs in a SHOW command. Customers who have a decentralized setup have different teams managing DR and data sharing, where the person setting up RG is different from those setting up FGs. Suppose a team managing a DR setup performs a planned/unplanned failover. In that case, it results in a limited experience for the sharing person who would no longer be able to modify the RG primary. There may be a requirement for the person responsible for RG setup to know why they are no longer able to modify their primary RG from the original primary account and contact the FG owner to resolve it.

When RG and FG overlap to satisfy configuration (a) above, the replication service implicitly tracks this association. In some aspects, the SHOW REPLICATION GROUP experience can be extended to include column ‘linked_failover_group.’ This field can be populated for primary RG and secondary RG (in the DR accounts) and shows the fully qualified name of the failover group (e.g., MYORG.MYACCOUNT1.MYFG) to which they are linked implicitly (if available).

In some aspects, DRM 132 can configure implicitly managing RG replica in a target DR account. To satisfy configuration (c) above, DRM 132 creates and manages the RG replica on the DR account. The RG replica in the DR account is created as part of the first FG refresh after the link is formed on the primary. This RG replica that gets created automatically in the DR account shows up as any other RG replica (in the SHOW command). Any operations on the managed RG replica are blocked until the linked failover group fails over, making the RG primary in the DR account.

In some aspects, DRM 132 can create and alter the experience for RG and FG. In some aspects, customers can be asked to create the RGs and FGs in their primary DR and consumer accounts.

In some aspects, DRM 132 validates configurations (a) and (c) described above at the time of CREATE RG/FG and ALTER RG/FG to prevent operations that may result in refresh failure. In some cases, these validations may (or may not) occur transactionally along with whatever caused the RG/FG membership to change (e.g., grant/revoke of usage on DB to share, a drop role, or a revoke all from the role). In such cases, replication refresh would fail.

In some aspects, DRM 132 configures a refresh experience for RG and FG. Given that an object can be part of an RG replica and an FG replica with the same target DR account(s), the FG refresh controls when the objects are replicated from the source. RG replicas that are linked to FG replicas can be blocked from initiating a refresh. This is done to ensure a single point-in-time consistent version of the underlying data in these databases (and other objects), which is controlled by the FG refresh. Any tags applied to the RG primary are applied to the RG replica in the DR account when the FG refresh is complete.

In some aspects, validations of configurations (a) and (c) listed above are performed during RG refresh initiated by any of the RG replicas because these configurations can be violated due to certain non-transactional flows in how replication tracks RG members. For example, when RG replica in the consumer region is being refreshed (ALTER REPLICATION GROUP RG_replica REFRESH), it succeeds only after validation if the primary RG contains objects that are a subset of another single primary FG; else, refresh succeeds, given there is no overlap/DR for providers scenario.

In some aspects, DRM 132 configures sub-DB replication refresh experience for RG and FG. Sub-database replication for RGs is with ‘share-with-dependencies’ that performs a transitive closure and pulls in the objects required by a share. Sub-database replication for FGs is planned to be done with system tags that users set at a schema level (and potentially further granularity going forward). When such RGs and FGs overlap, DRM 132 can enforce configuration (b). If an RG refresh (for sharing purposes) captures objects that are not a part of the linked FG's (tag-based) sub-database closure, the RG refresh fails with an appropriate error, letting users know corrective actions they can take.

In some aspects, DRM 132 can execute such validations on FG refresh, too, where the DRM can run through all the linked RGs' closures and identify whether there is any entity needed by the RG that is not also a part of the FG's closure.

In some aspects, DRM 132 can configure a failover experience during an outage. During a planned drill or unplanned network outage, customers continue to have the same failover experience in their FGs based on the disclosed techniques. In addition, when a user triggers a failover on an FG, any RG replicas in that account containing a subset of objects from the FG will become the new primary RG. After the failover of the FG, the corresponding RG(s) becomes primary, and the refreshes to the consumer accounts for these RGs automatically resume (e.g., based on a pre-configured schedule).

When a failover of the FG is triggered, the ongoing RG refresh (from the consumer region) will continue to finish. The next time the RG refreshes to consumer regions are initiated, it will fetch from the new primary.

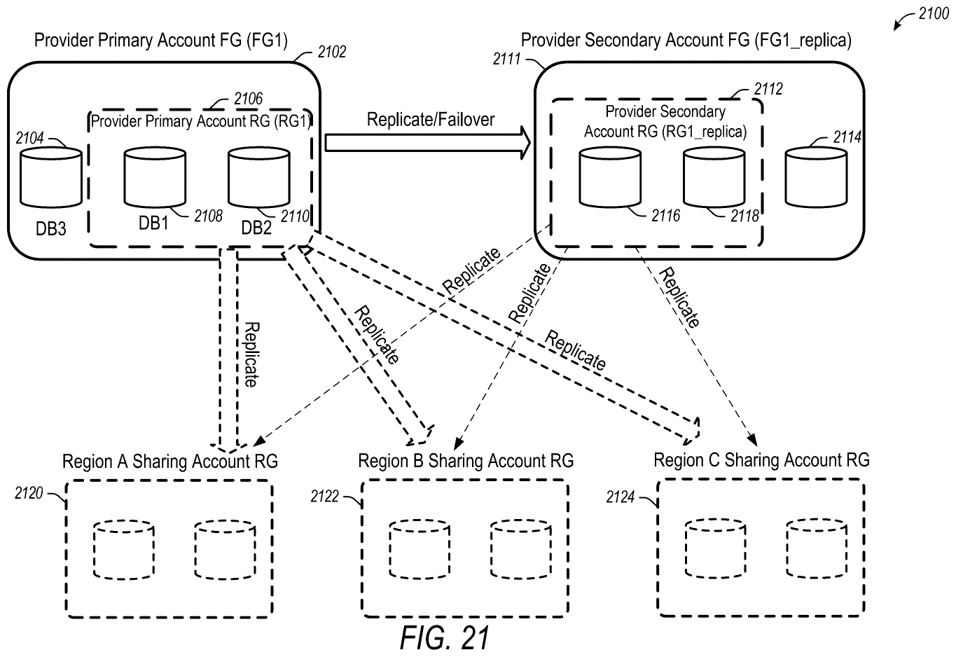

FIG. 21 is a diagram 2100 of using a failover group replica during a failover event where the failover group replica includes a single overlapping replication group, in accordance with some embodiments of the present disclosure. Referring to FIG. 21, FG 2102, which can be configured as a primary FG, includes DB 2104 and RG 2106 (including DB 2108 and DB 2110).

RG 2106 is used for data replication and data sharing with deployments 2120, 2122, and 2124. More specifically, deployments 2120-2124 are configured with read-only replicas of DBs 2108 and 2110.

DRM 132 can configure FG 2111 as a replica FG of FG 2102. FG 2111 includes DB 2114 (as a replica of DB 2104) and RG 2112 (as a replica of RG 2106). RG 2112 includes DBs 2116 and 2118 as replicas of DBs 2108 and 2110.

When FG 2102 fails over to the target region, RG 2112 in the target region automatically gets promoted to become the new primary. All the sharing account targets (e.g., deployments 2120-2124) for RG continue to be serviced from the newly promoted primary.

More specifically, after a failover event, FG 2111 can be promoted as a primary FG, and data replication and sharing with deployments 2120-2124 can resume from RG 2112 (which is now promoted as the primary RG after the failover event).

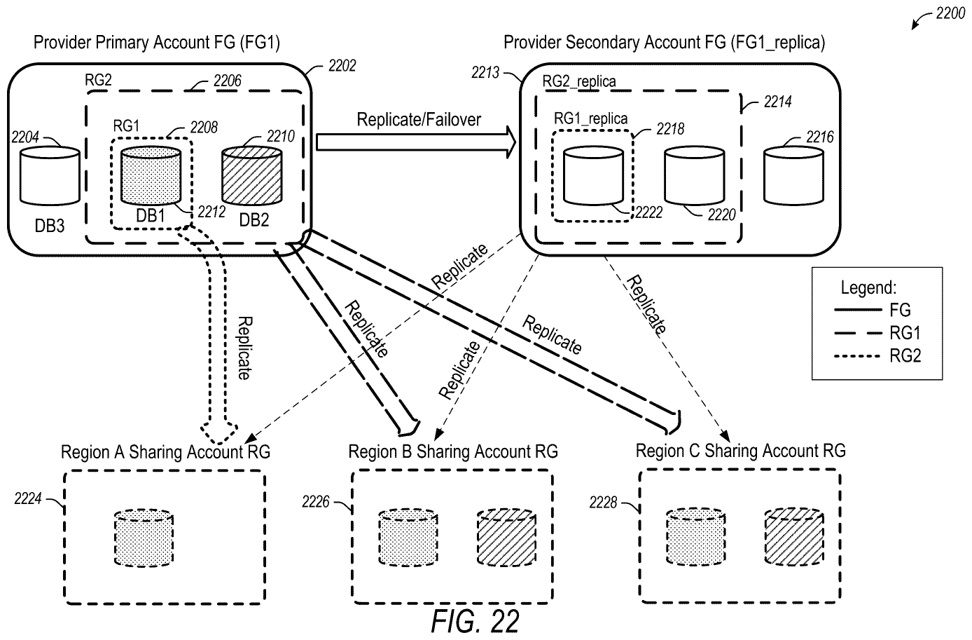

FIG. 22 is a diagram 2200 of using a failover group replica during a failover event where the failover group replica includes multiple overlapping replication groups, in accordance with some embodiments of the present disclosure. Referring to FIG. 22, FG 2202, which can be configured as a primary FG, includes DB 2204 and RG 2206. RG 2206 includes RG 2208 (including DB 2212) and DB 2210. RG 2206 is used for data replication and data sharing with deployments 2224, 2226, and 2228. More specifically, deployments 2224-2228 are configured with read-only replicas of DBs 2212 and 2210 (as illustrated in FIG. 22).

DRM 132 can configure FG 2213 as a replica FG of FG 2202. FG 2213 includes DB 2216 (as a replica of DB 2204) and RG 2214 (as a replica of RG 2206). RG 2214 includes RG 2218 with DB 2222 (as a replica of RG 2208 with DB 2212) and DB 2220 (as a replica of DB 2210).

When FG 2202 fails over to the target account as FG 2213, both RG 2218 and RG 2214 also get promoted to become primary in the target account. The sharing accounts (e.g., at deployments 2224-2228) for each of the RGs continue to be serviced from the newly promoted primary.

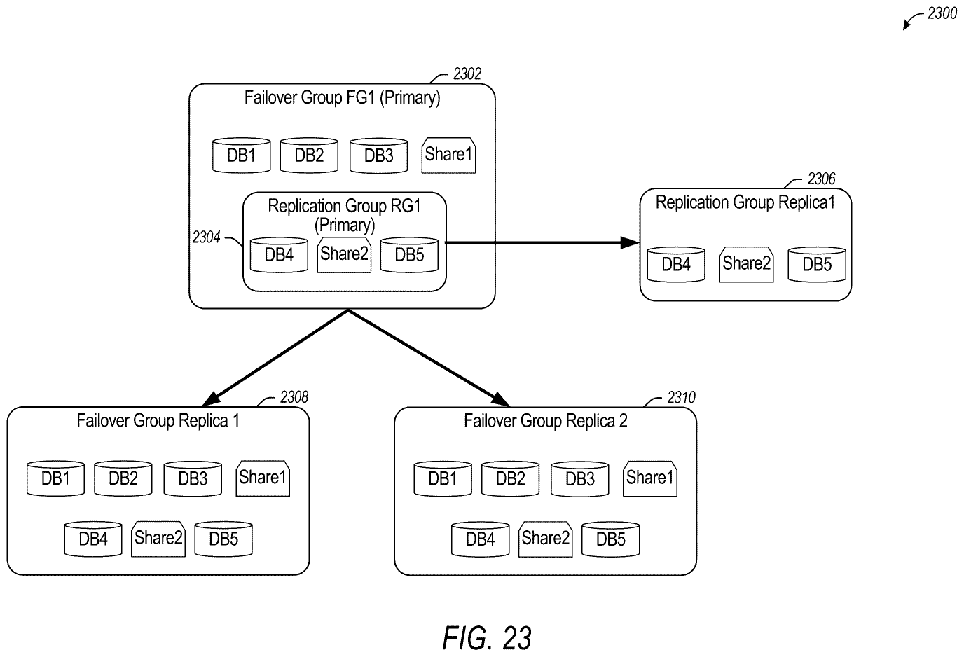

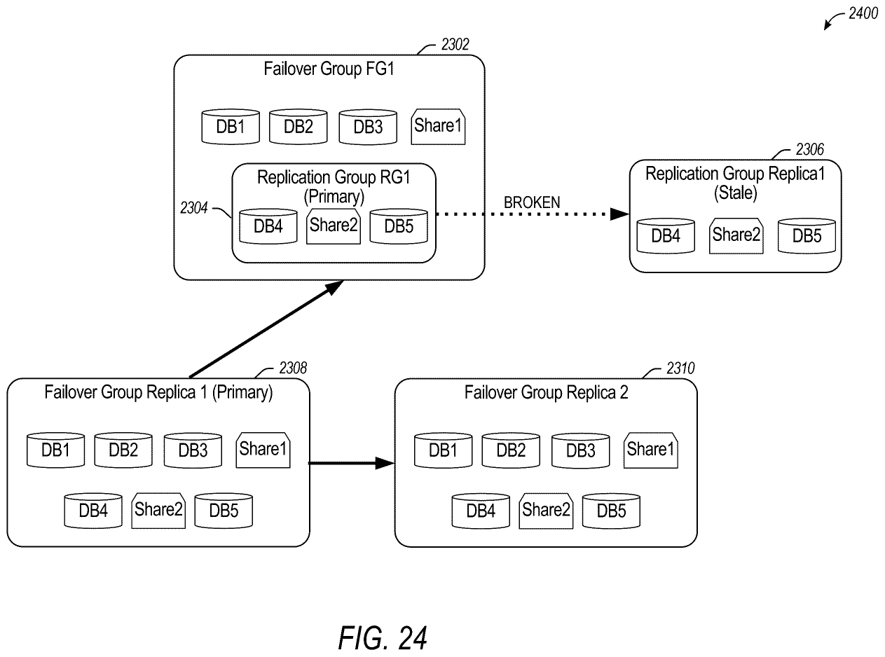

FIG. 23 is a diagram 2300 of generating failover group replicas and a replication group replica before a failover event using a primary failover group with a single overlapping replication group, in accordance with some embodiments of the present disclosure. Referring to FIG. 23, before a failover event, FG 2302 (including DB1, DB2, DB3, share1, and RG 2304 with DB4, DB5, and share2) is configured as the primary FG. RG 2304 is replicated to RG replica 2306 for performing data sharing. Additionally, FG 2302 is replicated as FG replicas 2308 and 2310. As illustrated in FIG. 23, the FG replicas 2308 and 2310 do not include any RGs, such as copies of RG 2304. Instead, the FG replicas 2308 and 2310 only include the data objects of FG 2302 without any RG association. The result after a failover event is illustrated in FIG. 24.

FIG. 24 is a diagram 2400 of the primary failover group of FIG. 23 after a failover event, in accordance with some embodiments of the present disclosure. Referring to FIG. 24, after a failover event, the refreshing link to the RG replica 2306 is broken, and data in the RG replica becomes stale. The FG replica 2308 is promoted as primary, and only FG replication (for DR) is performed without RG replication for data sharing.

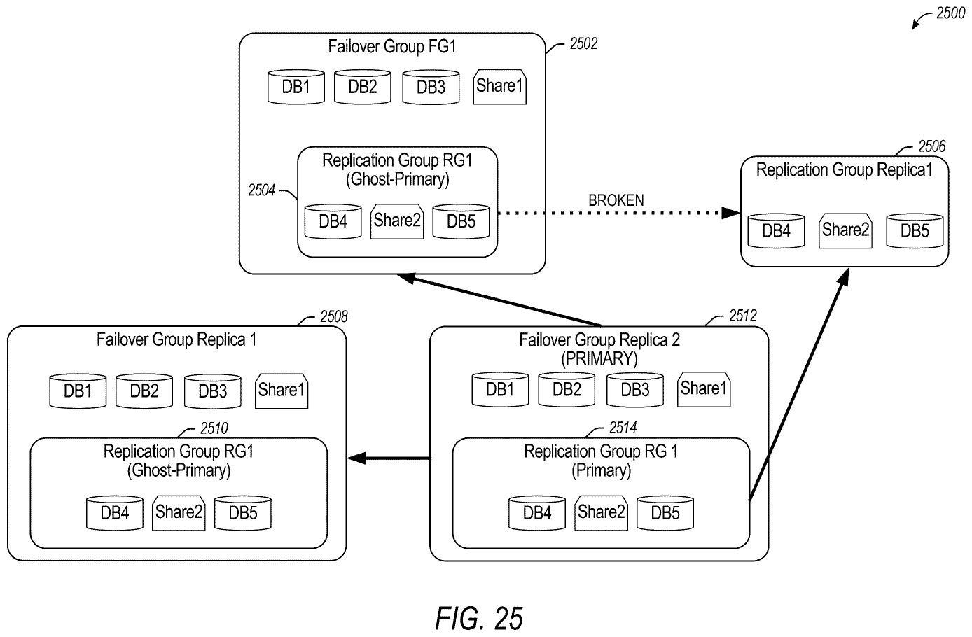

Using the disclosed techniques, overlapping RG and FG can be configured so that DR for data sharing can be performed (e.g., as illustrated in FIG. 25).

FIG. 25 is a diagram 2500 of configuring a new primary failover group after a failover event using a primary failover group with a single overlapping replication group, in accordance with some embodiments of the present disclosure. Referring to FIG. 25, FG 2502 (including DB1, DB2, DB3, share1, and RG 2504 with DB4, DB5, and share2) is configured as the primary FG. RG 2504 is replicated to RG replica 2506 for performing data sharing. Additionally, FG 2502 is replicated as FG replicas 2508 and 2510, which replicas also include corresponding RG replicas 2510 and 2514.

After the failover event, the link between FG 2502 and RG 2506 is broken. However, FG replica 2512 is promoted as a primary FG, and refreshing RG 2506 continues using RG replica 2514 (which is now promoted as a primary RG). Replication of FG 2512 to now replica FGs 2502 and 2508 can continue as well.

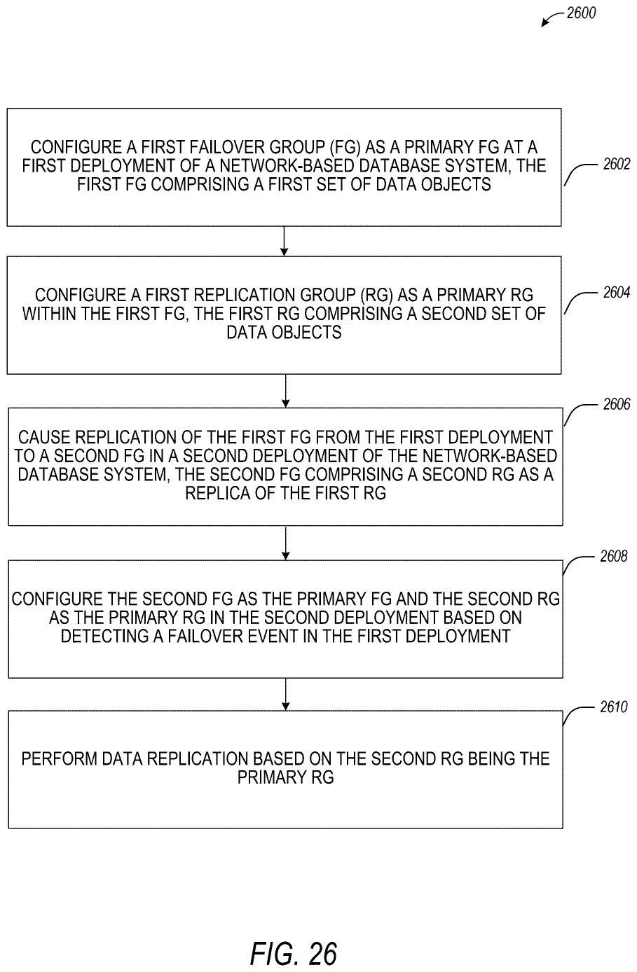

FIG. 26 is a flow diagram illustrating operations of a database system in performing method 2600 for configuring disaster recovery for data sharing, in accordance with some embodiments of the present disclosure. Method 2600 may be embodied in computer-readable instructions for execution by one or more hardware components (e.g., one or more processors) such that the operations of method 2600 may be performed by components of the network-based database system 102, such as a network node (e.g., DRM 132 executing on a network node of the compute service manager 108) or computing device (e.g., client device 114) which may be implemented as machine 2700 of FIG. 27 and may be configured with an application connector performing the disclosed functions. Accordingly, method 2600 is described below, by way of example with reference thereto. However, it should be noted that method 2600 may be deployed on various other hardware configurations and is not intended to be limited to deployment within the network-based database system 102.

At operation 2602, DRM 132 configures a first failover group (FG) as a primary FG at a first deployment of a network-based database system. The first FG includes a first set of data objects.

At operation 2604, DRM 132 configures a first replication group (RG) as a primary RG within the first FG. The first RG includes a second set of data objects.

At operation 2606, DRM 132 causes replication of the first FG from the first deployment to a second FG in a second deployment of the network-based database system. The second FG includes a second RG as a replica of the first RG. In this regard, each FG replica now will contain a “ghost RG primary” (which is also referred as a “second RG”). If any other FG replica becomes primary, the local ghost RG primary becomes the actual primary for the RG. All the other RGs present in other FG replicas become ghost RG in turn.

At operation 2608, DRM 132 configures the second FG as the primary FG and the second RG (which is the ghost RG primary) as the primary RG in the second deployment based on detecting a failover event in the first deployment.

At operation 2610, DRM 132 performs data replication based on the second RG being the primary RG.

FIG. 27 illustrates a diagrammatic representation of a machine 2700 in the form of a computer system within which a set of instructions may be executed for causing the machine 2700 to perform any one or more of the methodologies discussed herein, according to an example embodiment. Specifically, FIG. 27 shows a diagrammatic representation of machine 2700 in the example form of a computer system, within which instructions 2716 (e.g., software, a program, an application, an applet, an app, or other executable code) for causing the machine 2700 to perform any one or more of the methodologies discussed herein may be executed. For example, instructions 2716 may cause machine 2700 to execute any one or more operations of method 2600 (or any other technique discussed herein, for example, in connection with FIG. 4-FIG. 26). As another example, instructions 2716 may cause machine 2700 to implement one or more portions of the functionalities discussed herein. In this way, instructions 2716 may transform a general, non-programmed machine into a particular machine 2700 (e.g., the client device 114, the compute service manager 108, or a node in the execution platform 110) that is specially configured to carry out any one of the described and illustrated functions in the manner described herein. In yet another embodiment, instructions 2716 may configure the client device 114, the compute service manager 108, and/or a node in the execution platform 110 to carry out any one of the described and illustrated functions in the manner described herein.

In alternative embodiments, the machine 2700 operates as a standalone device or may be coupled (e.g., networked) to other machines. In a networked deployment, the machine 2700 may operate in the capacity of a server machine or a client machine in a server-client network environment or as a peer machine in a peer-to-peer (or distributed) network environment. The machine 2700 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 2716, sequentially or otherwise, that specify actions to be taken by the machine 2700. Further, while only a single machine 2700 is illustrated, the term “machine” shall also be taken to include a collection of machines 2700 that individually or jointly execute the instructions 2716 to perform any one or more of the methodologies discussed herein.

Machine 2700 includes processors 2710, memory 2730, and input/output (I/O) components 2750 configured to communicate with each other such as via a bus 2702. In some example embodiments, the processors 2710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 2712 and a processor 2714 that may execute the instructions 2716. The term “processor” is intended to include multi-core processors 2710 that may comprise two or more independent processors (sometimes referred to as “cores”) that may execute instructions 2716 contemporaneously. Although FIG. 27 shows multiple processors 2710, machine 2700 may include a single processor with a single core, a single processor with multiple cores (e.g., a multi-core processor), multiple processors with a single core, multiple processors with multiple cores, or any combination thereof.

The memory 2730 may include a main memory 2732, a static memory 2734, and a storage unit 2736, all accessible to processors 2710, such as via the bus 2702. The main memory 2732, the static memory 2734, and the storage unit 2736 store the instructions 2716, embodying any one or more of the methodologies or functions described herein. The instructions 2716 may also reside, completely or partially, within the main memory 2732, within the static memory 2734, within machine storage medium 2738 of the storage unit 2736, within at least one of the processors 2710 (e.g., within the processor's cache memory), or any suitable combination thereof, during execution thereof by the machine 2700.

The I/O components 2750 include components to receive input, provide output, produce output, transmit information, exchange information, capture measurements, and so on. The specific I/O components 2750 that are included in a particular machine 2700 will depend on the type of machine. For example, portable machines such as mobile phones will likely include a touch input device or other such input mechanisms, while a headless server machine will likely not include such a touch input device. It would be appreciated that the I/O components 2750 may include many other components that are not shown in FIG. 27. The I/O components 2750 are grouped according to functionality merely to simplify the following discussion, and the grouping is in no way limiting. In various example embodiments, the I/O components 2750 may include output components 2752 and input components 2754. The output components 2752 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 2754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 2750 may include communication components 2764, operable to couple the machine 2700 to a network 2780 or devices 2770 via a coupling 2782 and a coupling 2772, respectively. For example, communication components 2764 may include a network interface component or another device that can interface with network 2780. In further examples, the communication components 2764 may include wired communication components, wireless communication components, cellular communication components, and other communication components to provide communication via other modalities. The device 2770 may be another machine or any of a wide variety of peripheral devices (e.g., a peripheral device coupled via a universal serial bus (USB)). For example, as noted above, machine 2700 may correspond to any one of the client device 114, the compute service manager 108, or the execution platform 110, and the devices 2770 may include the client device 114 or any other computing device described herein as being in communication with the network-based database system 102 or the cloud storage platform 104.

The various memories (e.g., 2730, 2732, 2734, and/or memory of the processor(s) 2710 and/or the storage unit 2736) may store one or more sets of instructions 2716 and data structures (e.g., software) embodying or utilized by any one or more of the methodologies or functions described herein. These instructions 2716, when executed by the processor(s) 2710, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database and/or associated caches and servers) that store executable instructions and data. The terms shall accordingly be taken to include, but not be limited to, solid-state memories and optical and magnetic media, including memory internal or external to processors. Specific examples of machine-storage media, computer-storage media, and/or device-storage media include non-volatile memory, including by way of example, semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” (or the plural form “media”) specifically exclude carrier waves, modulated data signals, and other such media, at least some of which are covered under the term “signal medium” discussed below.

In various example embodiments, one or more portions of the network 2780 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 2780 or a portion of the network 2780 may include a wireless or cellular network, and the coupling 2782 may be a Code Division Multiple Access (CDMA) connection, a Global System for Mobile communications (GSM) connection, or another cellular or wireless coupling. In this example, the coupling 2782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 2716 may be transmitted or received over the network 2780 using a transmission medium via a network interface device (e.g., a network interface component included in the communication components 2764) and utilizing any one of several well-known transfer protocols (e.g., hypertext transfer protocol (HTTP)). Similarly, instructions 2716 may be transmitted or received using a transmission medium via coupling 2772 (e.g., a peer-to-peer coupling or another wired or wireless network coupling) to device 2770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 2716 for execution by the machine 2700 and include digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of method 2600 may be performed by one or more processors. The performance of certain of the operations may be distributed among the one or more processors, not only residing within a single machine but also deployed across several machines. In some example embodiments, the processor or processors may be located in a single location (e.g., within a home environment, an office environment, or a server farm), while in other embodiments, the processors may be distributed across several locations.

Described implementations of the subject matter can include one or more features, alone or in combination, as illustrated below by way of examples.

Example 1 is a system comprising at least one hardware processor and at least one memory storing instructions that cause the at least one hardware processor to perform operations comprising configuring a first failover group (FG) as a primary FG at a first deployment of a network-based database system, the first FG comprising a first set of data objects; configuring a first replication group (RG) as a current primary RG within the first FG, the first RG comprising a second set of data objects; causing replication of the first FG from the first deployment to a second FG in a second deployment of the network-based database system, the second FG comprising a second RG as a replica of the first RG; configuring the second FG as the primary FG and the second RG as the current primary RG in the second deployment based on detecting a failover event in the first deployment; and performing data replication based on the second RG being the current primary RG.

In Example 2, the subject matter of Example 1 includes subject matter where the instructions further cause the at least one hardware processor to perform operations comprising: configuring the second set of data objects to include one or more databases and a share object.

In Example 3, the subject matter of Example 2 includes subject matter where the instructions further cause the at least one hardware processor to perform operations comprising: causing replication of the one or more databases from the first RG to a third RG in a third deployment prior to the detecting of the failover event.

In Example 4, the subject matter of Example 3 includes subject matter where the replication of the one or more databases from the first RG to the third RG in the third deployment is based on the share object.

In Example 5, the subject matter of Examples 3-4 includes subject matter where the instructions further cause the at least one hardware processor to perform operations comprising performing the data replication as a replication of the second set of data objects from the current primary RG in the second deployment to the third RG in the third deployment.

In Example 6, the subject matter of Examples 3-5 includes subject matter where the instructions further cause the at least one hardware processor to perform operations comprising: configuring the first RG as a plurality of overlapping RGs associated with the first FG.

In Example 7, the subject matter of Example 6 includes subject matter where the instructions further cause the at least one hardware processor to perform operations comprising: sharing one or more data objects of the second set of data objects associated with the plurality of overlapping RGs with a corresponding plurality of non-overlapping RGs.

In Example 8, the subject matter of Example 7 includes subject matter where the instructions further cause the at least one hardware processor to perform operations comprising: detecting an update of the one or more data objects of the second set of data objects in the plurality of overlapping RGs.

In Example 9, the subject matter of Example 8 includes subject matter where the instructions further cause the at least one hardware processor to perform operations comprising: performing a refresh of the one or more data objects of the second set of data objects in the plurality of non-overlapping RGs based on the update.

In Example 10, the subject matter of Examples 7-9 includes subject matter where the plurality of non-overlapping RGs is associated with different deployments of the network-based database system.

Example 11 is a method comprising configuring, by at least one hardware processor, a first failover group (FG) as a primary FG at a first deployment of a network-based database system, the first FG comprising a first set of data objects; configuring a first replication group (RG) as a current primary RG within the first FG, the first RG comprising a second set of data objects; causing replication of the first FG from the first deployment to a second FG in a second deployment of the network-based database system, the second FG comprising a second RG as a replica of the first RG; configuring the second FG as the primary FG and the second RG as the current primary RG in the second deployment based on detecting a failover event in the first deployment; and performing data replication based on the second RG being the current primary RG.

In Example 12, the subject matter of Example 11 includes configuring the second set of data objects to include one or more databases and a share object.

In Example 13, the subject matter of Example 12 includes causing replication of the one or more databases from the first RG to a third RG in a third deployment prior to the detecting of the failover event.

In Example 14, the subject matter of Example 13 includes subject matter where the replication of the one or more databases from the first RG to the third RG in the third deployment is based on the share object.

In Example 15, the subject matter of Examples 13-14 includes performing the data replication as a replication of the second set of data objects from the current primary RG in the second deployment to the third RG in the third deployment.

In Example 16, the subject matter of Examples 13-15 includes configuring the first RG as a plurality of overlapping RGs associated with the first FG.

In Example 17, the subject matter of Example 16 includes sharing one or more data objects of the second set of data objects associated with the plurality of overlapping RGs with a corresponding plurality of non-overlapping RGs.

In Example 18, the subject matter of Example 17 includes detecting an update of the one or more data objects of the second set of data objects in the plurality of overlapping RGs.

In Example 19, the subject matter of Example 18 includes performing a refresh of the one or more data objects of the second set of data objects in the plurality of non-overlapping RGs based on the update.

In Example 20, the subject matter of Examples 17-19 includes subject matter where the plurality of non-overlapping RGs is associated with different deployments of the network-based database system.

Example 21 is a computer-storage medium comprising instructions that, when executed by one or more processors of a machine, configure the machine to perform operations comprising configuring a first failover group (FG) as a primary FG at a first deployment of a network-based database system, the first FG comprising a first set of data objects; configuring a first replication group (RG) as a current primary RG within the first FG, the first RG comprising a second set of data objects; causing replication of the first FG from the first deployment to a second FG in a second deployment of the network-based database system, the second FG comprising a second RG as a replica of the first RG; configuring the second FG as the primary FG and the second RG as the current primary RG in the second deployment based on detecting a failover event in the first deployment; and performing data replication based on the second RG being the current primary RG.

In Example 22, the subject matter of Example 21 includes operations such as configuring the second set of data objects to include one or more databases and a share object.

In Example 23, the subject matter of Example 22 includes operations such as causing replication of the one or more databases from the first RG to a third RG in a third deployment prior to the detecting of the failover event.

In Example 24, the subject matter of Example 23 includes subject matter where the replication of the one or more databases from the first RG to the third RG in the third deployment is based on the share object.

In Example 25, the subject matter of Examples 23-24 includes operations such as performing the data replication as a replication of the second set of data objects from the current primary RG in the second deployment to the third RG in the third deployment.

In Example 26, the subject matter of Examples 23-25 includes operations such as configuring the first RG as a plurality of overlapping RGs associated with the first FG.

In Example 27, the subject matter of Example 26 includes operations such as sharing one or more data objects of the second set of data objects associated with the plurality of overlapping RGs with a corresponding plurality of non-overlapping RGs.

In Example 28, the subject matter of Example 27 includes operations such as detecting an update of the one or more data objects of the second set of data objects in the plurality of overlapping RGs.

In Example 29, the subject matter of Example 28 includes operations such as performing a refresh of the one or more data objects of the second set of data objects in the plurality of non-overlapping RGs based on the update.

In Example 30, the subject matter of Examples 27-29 includes subject matter where the plurality of non-overlapping RGs is associated with different deployments of the network-based database system.

Example 31 is at least one machine-readable medium including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments and other embodiments not specifically described herein will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
configuring a first failover group (FG) as a primary FG at a first deployment of a network-based database system, the first FG comprising a first set of data objects;
configuring a first replication group (RG) as a current primary RG within the first FG, the first RG comprising a second set of data objects;
causing replication of the first FG from the first deployment to a second FG in a second deployment of the network-based database system, the second FG comprising a second RG as a replica of the first RG;
configuring the second FG as the primary FG and the second RG as the current primary RG in the second deployment based on detecting a failover event in the first deployment; and
performing data replication based on the second RG being the current primary RG.

2. The system of claim 1, wherein the instructions further cause the at least one hardware processor to perform operations comprising:
configuring the second set of data objects to include one or more databases and a share object.

3. The system of claim 2, wherein the instructions further cause the at least one hardware processor to perform operations comprising:
causing replication of the one or more databases from the first RG to a third RG in a third deployment prior to the detecting of the failover event.

4. The system of claim 3, wherein the replication of the one or more databases from the first RG to the third RG in the third deployment is based on the share object.

5. The system of claim 3, wherein the instructions further cause the at least one hardware processor to perform operations comprising:
performing the data replication as a replication of the second set of data objects from the current primary RG in the second deployment to the third RG in the third deployment.

6. The system of claim 3, wherein the instructions further cause the at least one hardware processor to perform operations comprising:
configuring the first RG as a plurality of overlapping RGs associated with the first FG.

7. The system of claim 6, wherein the instructions further cause the at least one hardware processor to perform operations comprising:
sharing one or more data objects of the second set of data objects associated with the plurality of overlapping RGs with a corresponding plurality of non-overlapping RGs.

8. The system of claim 7, wherein the instructions further cause the at least one hardware processor to perform operations comprising:
detecting an update of the one or more data objects of the second set of data objects in the plurality of overlapping RGs.

9. The system of claim 8, wherein the instructions further cause the at least one hardware processor to perform operations comprising:
performing a refresh of the one or more data objects of the second set of data objects in the plurality of non-overlapping RGs based on the update.

10. The system of claim 7, wherein the plurality of non-overlapping RGs is associated with different deployments of the network-based database system.

11. A method comprising:
configuring, by at least one hardware processor, a first failover group (FG) as a primary FG at a first deployment of a network-based database system, the first FG comprising a first set of data objects;
configuring a first replication group (RG) as a current primary RG within the first FG, the first RG comprising a second set of data objects;
causing replication of the first FG from the first deployment to a second FG in a second deployment of the network-based database system, the second FG comprising a second RG as a replica of the first RG;
configuring the second FG as the primary FG and the second RG as the current primary RG in the second deployment based on detecting a failover event in the first deployment; and
performing data replication based on the second RG being the current primary RG.

12. The method of claim 11, further comprising:
configuring the second set of data objects to include one or more databases and a share object.

13. The method of claim 12, further comprising:
causing replication of the one or more databases from the first RG to a third RG in a third deployment prior to the detecting of the failover event.

14. The method of claim 13, wherein the replication of the one or more databases from the first RG to the third RG in the third deployment is based on the share object.

15. The method of claim 13, further comprising:
performing the data replication as a replication of the second set of data objects from the current primary RG in the second deployment to the third RG in the third deployment.

16. The method of claim 13, further comprising:
configuring the first RG as a plurality of overlapping RGs associated with the first FG.

17. The method of claim 16, further comprising:
sharing one or more data objects of the second set of data objects associated with the plurality of overlapping RGs with a corresponding plurality of non-overlapping RGs.

18. The method of claim 17, further comprising:
detecting an update of the one or more data objects of the second set of data objects in the plurality of overlapping RGs.

19. The method of claim 18, further comprising:
performing a refresh of the one or more data objects of the second set of data objects in the plurality of non-overlapping RGs based on the update.

20. The method of claim 17, wherein the plurality of non-overlapping RGs is associated with different deployments of the network-based database system.

21. A computer-storage medium comprising instructions that, when executed by one or more processors of a machine, configure the machine to perform operations comprising:
configuring a first failover group (FG) as a primary FG at a first deployment of a network-based database system, the first FG comprising a first set of data objects;
configuring a first replication group (RG) as a current primary RG within the first FG, the first RG comprising a second set of data objects;
causing replication of the first FG from the first deployment to a second FG in a second deployment of the network-based database system, the second FG comprising a second RG as a replica of the first RG;
configuring the second FG as the primary FG and the second RG as the current primary RG in the second deployment based on detecting a failover event in the first deployment; and
performing data replication based on the second RG being the current primary RG.

22. The computer-storage medium of claim 21, the operations further comprising:
configuring the second set of data objects to include one or more databases and a share object.

23. The computer-storage medium of claim 22, the operations further comprising:
causing replication of the one or more databases from the first RG to a third RG in a third deployment prior to the detecting of the failover event.

24. The computer-storage medium of claim 23, wherein the replication of the one or more databases from the first RG to the third RG in the third deployment is based on the share object.

25. The computer-storage medium of claim 23, the operations further comprising:
performing the data replication as a replication of the second set of data objects from the current primary RG in the second deployment to the third RG in the third deployment.

26. The computer-storage medium of claim 23, the operations further comprising:
configuring the first RG as a plurality of overlapping RGs associated with the first FG.

27. The computer-storage medium of claim 26, the operations further comprising:
sharing one or more data objects of the second set of data objects associated with the plurality of overlapping RGs with a corresponding plurality of non-overlapping RGs.

28. The computer-storage medium of claim 27, the operations further comprising:
detecting an update of the one or more data objects of the second set of data objects in the plurality of overlapping RGs.

29. The computer-storage medium of claim 28, the operations further comprising:
performing a refresh of the one or more data objects of the second set of data objects in the plurality of non-overlapping RGs based on the update.

30. The computer-storage medium of claim 27, wherein the plurality of non-overlapping RGs is associated with different deployments of the network-based database system.
